(19) United States
(12) Patent Application Publication
(10) Pub. No.: US 2026/0050108 A1
(43) Pub. Date: Feb. 19, 2026

(54) IMAGE SENSOR

(71) Applicant: Samsung Electronics Co., Ltd., Suwon-si (KR)

(72) Inventors: Jongwoo HONG, Suwon-si (KR); Inyong PARK, Suwon-si (KR); Shinho LEE, Suwon-si (KR); Insung JOE, Suwon-si (KR)

(73) Assignee: Samsung Electronics Co., Ltd., Suwon-si (KR)

(21) Appl. No.: 19/250,437

(22) Filed: Jun. 26, 2025

(30) Foreign Application Priority Data
Aug. 14, 2024 (KR) 10-2024-0108968

(51) Int. Cl. G02B 1/115; G02B 1/00; G02B 19/00

(52) U.S. Cl. CPC G02B 1/115; G02B 1/002; G02B 19/0076

(57) ABSTRACT

An image sensor includes a sensor substrate including a plurality of first pixels and a plurality of second pixels, wherein the plurality of first pixels are configured to sense light of a first wavelength, and the plurality of second pixels are configured to sense light of a second wavelength that is different from the first wavelength, and first color filters and second color filters arranged above the sensor substrate and corresponding the plurality of first pixels and the plurality of second pixels, respectively.

### CROSS-REFERENCE TO RELATED APPLICATION

This application is based on and claims priority under 35 U.S.C. § 119 to Korean Patent Application No. 10-2024-0108968, filed on Aug. 14, 2024, in the Korean Intellectual Property Office, the disclosure of which is incorporated by reference herein in its entirety.

### BACKGROUND

The inventive concepts relate to image sensors, and more particularly, to technologies for image sensors to which a meta-micro-lens is applied.

In general, an image sensor may include a component for condensing incident light. As an example of a light condenser, a meta-micro-lens array may be used, and light reflection occurring at a light-incident surface of the meta-micro-lens array ultimately lowers the efficiency of a sensing element.

### SUMMARY

Some example embodiments of the inventive concepts provide an image sensor with improved reliability. In some example embodiments, an image sensor may include an anti-reflection film to reduce the reflectance at a light-incident surface of a micro-lens array to thereby improve the efficiency of the image sensor. The anti-reflection film may include an oxide film or the like.

According to some example embodiments of the inventive concepts, an image sensor may include a sensor substrate including a plurality of first pixels and a plurality of second pixels, wherein the plurality of first pixels are configured to sense light of a first wavelength, and the plurality of second pixels are configured to sense light of a second wavelength different from the first wavelength. The image sensor may include first color filters and second color filters above the sensor substrate and corresponding the plurality of first pixels and the plurality of second pixels, respectively. The image sensor may include a transparent spacer on both the first color filters and the second color filters. The image sensor may include at least one meta-micro-lens array including a plurality of nano-posts above the transparent spacer and configured to condense incident light onto the plurality of first pixels and the plurality of second pixels. The image sensor may include a plurality of upper anti-reflection layers on a light-incident surface of the at least one meta-micro-lens array, wherein the plurality of upper anti-reflection layers are stacked to overlap each other in a vertical direction perpendicular to an upper surface of the sensor substrate, and refractive indices of the plurality of upper anti-reflection layers may increase toward the at least one meta-micro-lens array in the vertical direction.

According to some example embodiments of the inventive concepts, an image sensor may include a sensor substrate including a plurality of first pixels and a plurality of second pixels, wherein the plurality of first pixels are configured to sense light of a first wavelength, and the plurality of second pixels are configured to sense light of a second wavelength different from the first wavelength. The image sensor may include a transparent spacer arranged above the sensor substrate. The image sensor may include first color filters and second color filters between the sensor substrate and the transparent spacer and corresponding to the plurality of first pixels and the plurality of second pixels, respectively. The image sensor may include color filter fences between the first color filters and the second color filters. The image sensor may include a first meta-micro-lens array including a plurality of first nano-posts that are above the transparent spacer and configured to condense incident light onto the plurality of first pixels and the plurality of second pixels. The image sensor may include a second meta-micro-lens array above the first meta-micro-lens array and including a plurality of second nano-posts at positions in a horizontal direction that are different from positions of the plurality of first nano-posts in the horizontal direction, such that the plurality of second nano-posts are offset from the plurality of first nano-posts in the horizontal direction, the horizontal direction extending parallel to an upper surface of the sensor substrate. The images sensor may include a first etch stopper between the spacer and the first meta-micro-lens array. The image sensor may include a plurality of upper anti-reflection layers on a light-incident surface of the second meta-micro-lens array. The plurality of upper anti-reflection layers may be stacked to overlap each other in a vertical direction extending perpendicular to the upper surface of the sensor substrate. Refractive indices of the plurality of upper anti-reflection layers may increase toward the second meta-micro-lens array, the refractive indices of the plurality of upper anti-reflection layers may each be smaller than a refractive index of the first meta-micro-lens and greater than a refractive index of air.

According to some example embodiments of the inventive concepts, an image sensor may include a sensor substrate including a plurality of first pixels and a plurality of second pixels, wherein the plurality of first pixels are configured to sense light of a first wavelength, and the plurality of second pixels are configured to sense light of a second wavelength different from the first wavelength. The image sensor may include a plurality of lower anti-reflection layers on an upper surface of the sensor substrate. The image sensor may include a transparent spacer above the plurality of lower anti-reflection layers. The image sensor may include first color filters and second color filters arranged between the sensor substrate and the spacer and corresponding to the plurality of first pixels and the plurality of second pixels, respectively. The image sensor may include a first meta-micro-lens array including a plurality of first nano-posts that are above the transparent spacer and configured to condense incident light onto the plurality of first pixels and the plurality of second pixels. The image sensor may include a second meta-micro-lens array that is arranged above the first meta-micro-lens array and comprises a plurality of second nano-posts arranged at positions in a horizontal direction that are different from positions of the plurality of first nano-posts in the horizontal direction, such that the plurality of second nano-posts are offset from the plurality of first nano-posts in the horizontal direction, the horizontal direction extending parallel to the upper surface of the sensor substrate. The image sensor may include a first etch stopper between the spacer and the first meta-micro-lens array. The image sensor may include a plurality of upper anti-reflection layers on a light-incident surface of the second meta-micro-lens array. The plurality of upper anti-reflection layers may be stacked to overlap each other in a vertical direction extending perpendicular to the upper surface of the sensor substrate Refractive indices of the plurality of upper anti-reflection layers increase toward the second meta-micro-lens array in the vertical direction. Each of the first meta-micro-lens array and the second meta-micro-lens array may be configured to change a phase of the light of the first wavelength and then condense the light of the first wavelength onto each of the plurality of first pixels, and change a phase of the light of the second wavelength and then condense the light of the second wavelength onto each of the plurality of second pixels.

### BRIEF DESCRIPTION OF THE DRAWINGS

Example embodiments will be more clearly understood from the following detailed description taken in conjunction with the accompanying drawings in which:

FIG. 1 is a block diagram illustrating an image sensor according to some example embodiments;

FIGS. 2, 3, and 4 are diagrams illustrating various pixel arrangements in a pixel array of an image sensor, according to some example embodiments;

FIG. 5 is a cross-sectional view of an image sensor according to some example embodiments;

FIG. 6 is a plan view illustrating an arrangement of pixels in a pixel array according to some example embodiments;

FIG. 7 is a plan view illustrating a configuration of a meta-micro-lens array included in an image sensor, according to some example embodiments;

FIGS. 8 and 9 are cross-sectional views of image sensors according to some example embodiments;

FIGS. 10A, 10B, 10C, 10D, 10E, 10F, 10G, 10H, 10I, 10J, 10K, and 10L are enlarged views of region A of FIG. 5 according to some example embodiments;

FIG. 11 is a graph showing reflectance according to wavelengths of image sensors, according to some example embodiments;

FIG. 12 is a graph showing average reflectance of image sensors according to some example embodiments;

FIG. 13 is a block diagram of an electronic device including multiple camera modules according to some example embodiments;

FIG. 14 is a detailed block diagram of the camera module of FIG. 13 according to some example embodiments;

FIG. 15 is a block diagram illustrating a configuration of an image sensor according to some example embodiments;

FIG. 16 is a block diagram schematically illustrating an electronic device including an image sensor, according to some example embodiments; and

FIG. 17 is a block diagram schematically illustrating the camera module of FIG. 16 according to some example embodiments.

### DETAILED DESCRIPTION

As example embodiments described herein allow for various changes and numerous forms, some example embodiments will be illustrated in the drawings and described in detail. However, this is not intended to limit the example embodiments to particular modes of practice. Example embodiments described below are examples, and various modifications are possible from these example embodiments.

The use of any and all examples, or example language provided herein, is intended merely to describe the inventive concepts in more detail and does not pose a limitation on the scope of the inventive concepts unless otherwise claimed.

Unless otherwise specifically stated, in the specification, a vertical direction may be defined as a Z direction, and a first horizontal direction and a second horizontal direction may each be defined as a horizontal direction perpendicular to the Z direction. The first horizontal direction may be referred to as an X direction, and the second horizontal direction may be referred to as a Y direction. A vertical level may refer to a height level in the vertical direction (the Z direction). The vertical level may refer to a distance in the vertical direction (the Z direction) from a reference structure and/or surface (e.g., from the upper surface 110S of the sensor substrate 110). The horizontal width in the first horizontal direction may refer to a length in a horizontal direction (the X direction and/or the Y direction), and a vertical length may refer to a length in a vertical direction (the Z direction).

In order to clearly explain the present inventive concepts in the drawings, parts that are not related to the description are omitted, and similar parts are given similar reference numerals throughout the specification.

Additionally, expressions written in the singular may be interpreted as singular or plural, unless explicit expressions such as “one” or “single” are used. Terms containing ordinal numbers, such as first, second, etc., may be used to describe various elements, but the elements are not limited by these terms. These terms may be used for the purpose of distinguishing one component from another.

Throughout the specification, the term “connected” does not mean only that two or more constituent components are directly connected, but may also mean that two or more constituent components are indirectly connected through another constituent component. In addition, unless explicitly described to the contrary, the word “comprise”, and variations such as “comprises” or “comprising”, will be understood to imply the inclusion of stated elements but not the exclusion of any other elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “above” or “on” a reference element, it can be positioned above or below the reference element, and it is not necessarily referred to as being positioned “above” or “on” in a direction opposite to gravity.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular”, “substantially parallel”, or “substantially coplanar” with regard to other elements and/or properties thereof will be understood to be “perpendicular”, “parallel”, or “coplanar”, respectively, with regard to the other elements and/or properties thereof within manufacturing tolerances and/or material tolerances and/or have a deviation in magnitude and/or angle from “perpendicular”, “parallel”, or “coplanar”, respectively, with regard to the other elements and/or properties thereof that is equal to or less than 10% (e.g., a. tolerance of ±10%).

It will be understood that surfaces which may be referred to as being “flat” may be understood to be “planar” or “substantially planar.” It will be understood that surfaces which may be referred to as being “planar” may be “planar” or may be “substantially planar.” Surfaces that are “substantially planar” will be understood to be “planar” within manufacturing tolerances and/or material tolerances and/or have surface portions with a deviation in magnitude and/or angle from “planar,” respectively, with regard to the other portions of the surfaces that is equal to or less than 10% (e.g., a. tolerance of ±10%).

It will be understood that elements and/or properties thereof may be recited herein as being “identical”, “the same”, or “equal” as other elements and/or properties thereof, and it will be further understood that elements and/or properties thereof recited herein as being “identical” to, “the same” as, or “equal” to other elements and/or properties thereof may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to, equal to or substantially equal to, and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element or property is referred to as being identical to, equal to, or the same as another element or property, it should be understood that the element or property is the same as another element or property within a desired manufacturing or operational tolerance range (e.g., ±10%).

It will be understood that elements and/or properties thereof described herein as being “substantially” the same, equal, and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

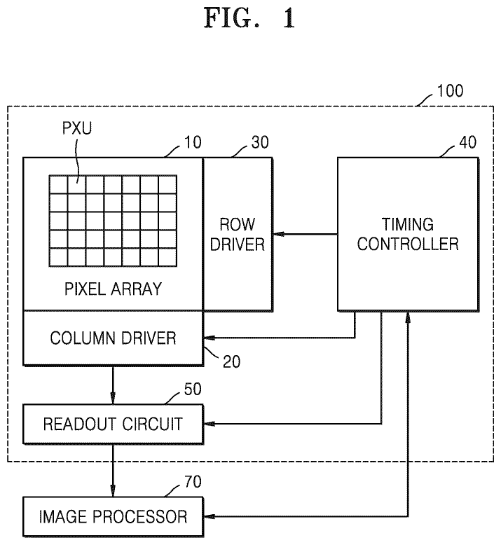

FIG. 1 is a block diagram illustrating an image sensor according to some example embodiments.

Referring to FIG. 1, an image sensor 100 according to the technical spirit of the inventive concepts may include a pixel array 10 and a plurality of circuits for controlling the pixel array 10.

In some example embodiments, the circuits for controlling the pixel array 10 may include a column driver 20, a row driver 30, a timing controller 40, and a readout circuit 50.

The image sensor 100 may operate according to a control command received from an image processor 70, and may convert light transferred from an external object into an electric signal and output the electric signal to the image processor 70. The image sensor 100 may be a complementary metal-oxide-semiconductor (CMOS) image sensor.

The pixel array 10 may include a plurality of pixel units PXU with a two-dimensional array structure, which are arranged in a matrix form along a plurality of row lines and a plurality of column lines. In the specification, a row refers to a set of a plurality of unit pixels arranged in a horizontal direction from among the plurality of unit pixels included in the pixel array 10, and a column refers to a set of a plurality of unit pixels arranged in a vertical direction from among the plurality of unit pixels included in the pixel array 10.

Each of the plurality of pixel units PXU may have a multi-pixel structure including a plurality of photodiodes. In each of the plurality of pixel units PXU, the plurality of photodiodes may receive light transferred from the object and thus generate electric charges. The image sensor 100 may perform an auto-focus function by using phase differences between pixel signals generated by the plurality of photodiodes included in each of the plurality of pixel units PXU. Each of the plurality of pixel units PXU may include a pixel circuit for generating a pixel signal from electric charges generated by the plurality of photodiodes.

The column driver 20 may include a correlated double sampler, an analog-to-digital converter, and the like. The correlated double sampler may be connected to the pixel units PXU, which are included in a row selected by a row selection signal supplied by the row driver 30, via column lines, and may detect a reset voltage and a pixel voltage by performing correlated double sampling. The analog-to-digital converter may convert the reset voltage and the pixel voltage, which are detected by the correlated double sampler, into a digital signal and transfer the digital signal to the readout circuit 50.

The readout circuit 50 may include a latch or a buffer circuit capable of temporarily storing a digital signal, an amplifier circuit, and the like, and may generate image data by temporarily storing or amplifying the digital signal received from the column driver 20. Operation timings of the column driver 20, the row driver 30, and the readout circuit 50 may be determined by the timing controller 40, and the timing controller 40 may be operated by a control command transmitted by the image processor 70.

The image processor 70 may perform signal processing on the image data output by the readout circuit 50, and output the processed image data to a display device or store it in a storage device such as a memory. In a case in which the image sensor 100 is mounted on an autonomous vehicle, the image processor 70 may perform image processing on the image data, and transmit the processed image data to a main controller or the like that controls the autonomous vehicle.

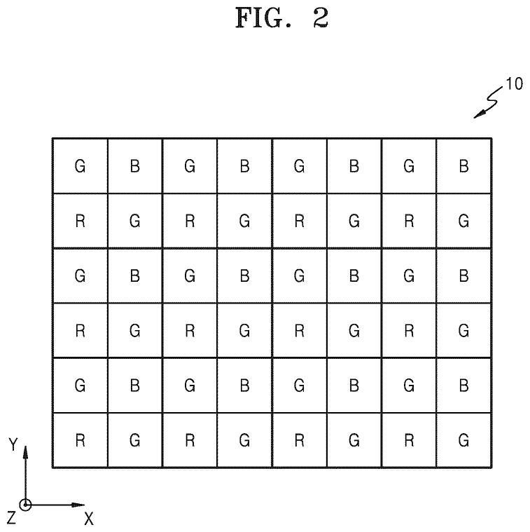

FIGS. 2, 3, and 4 are diagrams illustrating various pixel arrangements in a pixel array of an image sensor, according to some example embodiments.

The pixel array 10 may include a plurality of pixels to sense light of different wavelengths. The arrangement of the pixels may be implemented in various manners. For example, FIGS. 2 to 4 illustrate various example pixel arrangements in the pixel array 10 of the image sensor 100.

First, FIG. 2 shows a Bayer pattern, which is generally employed in the image sensor 100. Referring to FIG. 2, one unit pattern may include four quadrant regions, i.e., first to fourth quadrants, which may be a blue pixel B, a green pixel G, a red pixel R, and a green pixel G, respectively. The unit patterns are repeatedly arranged two-dimensionally in a first direction (the X direction) and a second direction (the Y direction). In other words, in a unit pattern in a 2×2 array form, two green pixels G are arranged in one diagonal direction, and one blue pixel B and one red pixel R are arranged in the opposite diagonal direction. In the overall pixel arrangement, a first row in which a plurality of green pixels G and a plurality of blue pixels B are alternately arranged in the first direction, and a second row in which a plurality of red pixels R and a plurality of green pixels G are alternately arranged in the first direction are repeatedly arranged in the second direction.

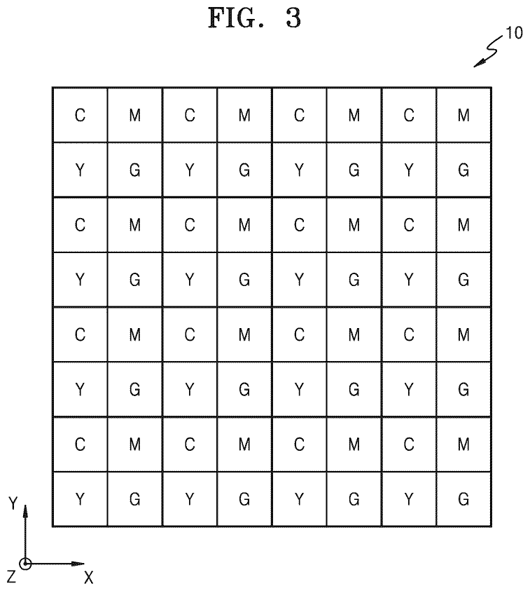

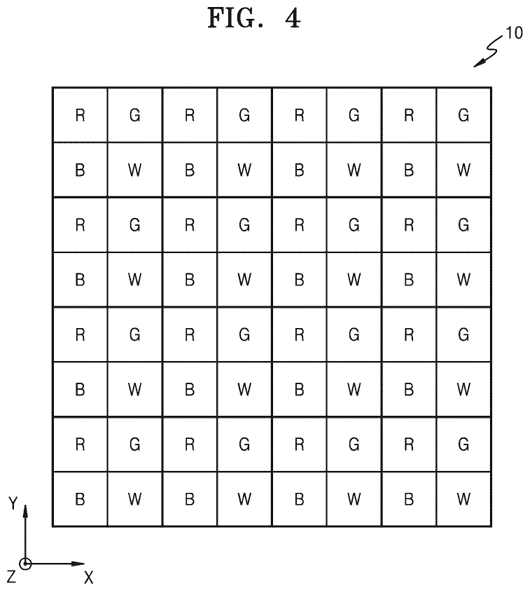

The pixels and/or pixel units of the pixel array 10 may be arranged according to various arrangement methods, such as a tetra arrangement or a nona arrangement, in addition to the Bayer pattern. For example, referring to FIG. 3, the pixel array 10 may also be arranged in a CYGM pattern in which a magenta pixel M, a cyan pixel C, a yellow pixel Y, and a green pixel G constitute one unit pattern. In addition, referring to FIG. 4, the pixel array 10 may also be arranged in an RGBW pattern in which a green pixel G, a red pixel R, a blue pixel B, and a white pixel W constitute one unit pattern. In addition, although not illustrated, the unit pattern may have a 3×2 array form. In addition, the pixels of the pixel array 10 may be arranged in various manners (e.g., various arrangements) depending on the color characteristics of the image sensor 100. Hereinafter, an example will be described in which the pixel array 10 of the image sensor 100 has a Bayer pattern, however, the operation principle may also be applied to other pixel arrangements than the Bayer pattern.

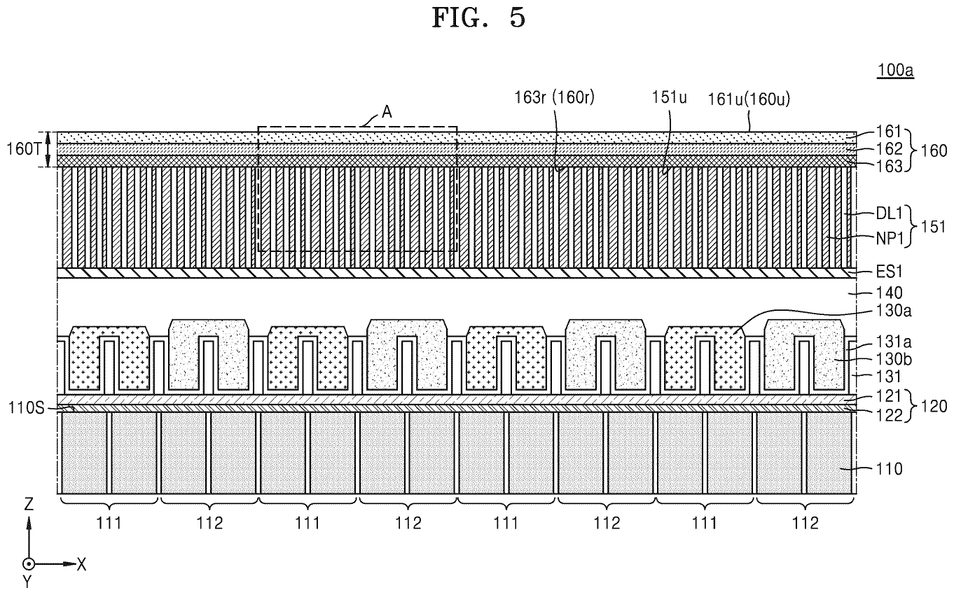

FIG. 5 is a cross-sectional view of an image sensor according to some example embodiments.

Referring to FIG. 5, an image sensor 100a may be included in and/or may be the image sensor 100 described above with reference to FIGS. 1 to 4 according to some example embodiments. The image sensor 100a may include a sensor substrate 110 including a plurality of first pixels 111 configured to sense light of a first wavelength, and a plurality of second pixels 112 to sense light of a second wavelength that is different from the first wavelength. The first wavelength may be a green light region (e.g., green wavelength spectrum) of the visible spectrum. The second wavelength may be a red light region (e.g., red wavelength spectrum) of the visible spectrum. Third pixels and fourth pixels are not illustrated in FIG. 5, but the third pixels and the fourth pixels may be illustrated in another cross-sectional view taken in a horizontal direction. That is, the first pixel 111 and the second pixel 112 of the inventive concepts may correspond to the third pixel and the fourth pixel. A pixel (e.g., the first and/or second pixels 111 and/or 112 may include, for example a silicon photodiode formed in a silicon sensor substrate 110.

The image sensor 100a may include two or more lower anti-reflection layers 120 arranged on (e.g., directly or indirectly on) an upper surface 110S of the sensor substrate 110. In FIG. 5, the lower anti-reflection layers 120 may include a first lower anti-reflection layer 121 and a second lower anti-reflection layer 122. However, the lower anti-reflection layers 120 are not limited thereto and may include three, four, or more lower anti-reflection layers. The lower anti-reflection layers 120 may improve the light use efficiency of a pixel array by reducing light reflected from the upper surface 110S of the sensor substrate 110 among incident light. In other words, the lower anti-reflection layers 120 help light incident from the outside to be sensed by the sensor substrate 110. As a result, the image sensor 100a (which may be included in and/or may be the image sensor 100) may have improved light sensitivity, improved light sensing and/or image generating performance, improved power consumption efficiency so as to sense light and/or generate images corresponding to the sensed light with reduced power consumption and/or to reduce power consumption without compromising light sensing and/or image generation performance, any combination thereof, or the like. Each of the first lower anti-reflection layer 121 and the second lower anti-reflection layer 122 may be formed to a thickness of about 80 nm to about 120 nm.

The image sensor 100a may include first color filters 130a arranged above the first pixels 111 (e.g., at least partially overlapping the first pixels 111 in the Z direction, which may be a direction extending perpendicular to the upper surface 110S), and second color filters 130b arranged above the second pixels 112 (e.g., at least partially overlapping the second pixels 112 in the Z direction, which may be a direction extending perpendicular to the upper surface 110S), and the first color filters 130a and the second color filters 130b are arranged above the sensor substrate 110. Although not illustrated, the image sensor 100a may further include third color filters arranged above third pixels 113, and fourth color filters arranged above fourth pixels 114. For example, the first color filters 130a and the fourth color filters may be green color filters that transmit only green light, the second color filters 130b may be blue color filters that transmit only blue light, and the third color filters may be red color filters that transmit only red light. In a case in which the image sensor 100a includes a first meta-micro-lens array 151 that is capable of not only simple light condensation but also color separation, light that has already been color-separated to a considerable extent by the first meta-micro-lens array 151 travels toward the first to fourth pixels 111, 112, 113, and 114, and thus, even when using the color filters 130a and 130b, light loss may be reduced, minimized, or prevented. The color purity of the image sensor 100a may be further improved by using the color filters 130a and 130b. However, the color filters 130a and 130b may be omitted in some example embodiments. For example in example embodiments where the color separation efficiency of the first meta-micro-lens array 151 is sufficiently high to be equal to or greater than a particular color separation efficiency threshold, the color filters 130a and 130b may be omitted.

The image sensor 100a including the pixel arrays described above may provide a sufficient amount of light to the pixels even when the size of the pixels is reduced because there is reduced, minimized, or prevented light loss (e.g., loss of incident light passing through the image sensor 100a from reaching a pixel) due to a color filter, for example, an organic color filter. As a result, the image sensor 100a (which may be included in and/or may be the image sensor 100) may have improved light sensitivity, improved light sensing and/or image generating performance, improved power consumption efficiency so as to sense light and/or generate images corresponding to the sensed light with reduced power consumption and/or to reduce power consumption without compromising light sensing and/or image generation performance, any combination thereof, or the like. Thus, it is possible to manufacture an ultra-high-resolution, ultra-small, high-sensitivity image sensor with hundreds of millions of pixels or more. The ultra-high-resolution, ultra-small, high-sensitivity image sensors may be employed in various high-performance optical devices or high-performance electronic devices. Such electronic devices may include, but are not limited to, smart phones, mobile phones, cell phones, personal digital assistants (PDAs), laptop computers, personal computers (PCs), various portable devices, home appliances, security cameras, medical cameras, automobiles, Internet-of-Things (IoT) devices, and other mobile or non-mobile computing devices.

In addition to the image sensor 100a, the electronic device may further include a processor configured to control the image sensor, for example, an application processor (AP), and may execute an operating system or an application program through the processor to control a plurality of hardware or software components and perform various data processes and computations. The processor may further include a graphics processing unit (GPU) and/or an image signal processor. In a case in which the processor includes an image signal processor, an image (or video) obtained by the image sensor may be stored and/or output by using the processor.

The image sensor 100a may include color filter fences 131 arranged between the first color filters 130a and the second color filters 130b (e.g., between immediately adjacent first and second color filters 130a and 130b in a horizontal direction that extends parallel to the upper surface 110S). The color filter fence 131 may also be arranged at the center (e.g., in the horizontal direction) of each of the first color filters 130a and the second color filters 130b. That is, the first color filters 130a and the second color filters 130b may each be formed to surround the outer circumferential surfaces of a separate at least one of the color filter fences 131. The color filter fences 131 may be arranged to be spaced apart at equal intervals in the horizontal direction. The intervals in the horizontal direction at which the color filter fences 131 are spaced apart are not limited to those illustrated in FIG. 5. The image sensor 100a may include a passivation layer 131a between the color filter fences 131 and the lower anti-reflection layers 120 and the first and second color filters 130a and 130b. The material of the passivation layer 131a may include, for example, SiO₂.

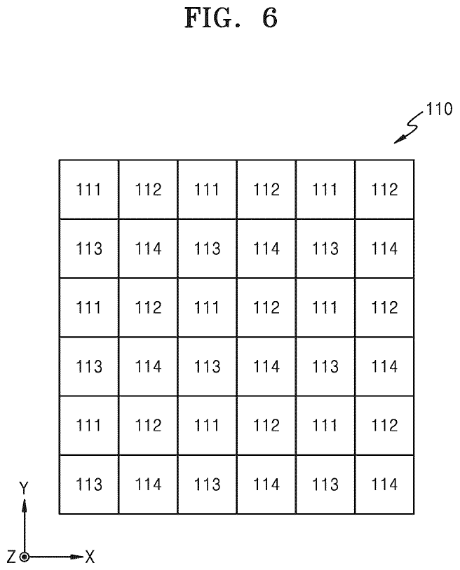

The image sensor 100a may include a transparent spacer 140 arranged on (e.g., directly or indirectly on) both the first color filters 130a and the second color filters 130b. The spacer 140 will be described in detail below with reference to FIG. 6.

The image sensor 100a may include the first meta-micro-lens array 151 and a first etch stopper ES1 that is arranged between (e.g., directly or indirectly between) the spacer 140 and the first meta-micro-lens array 151.

The first meta-micro-lens array 151 may include first nano-posts NP1 that are supported by the spacer 140, have a high refractive index, and change the phase of incident light, and a first dielectric layer DL1 that is formed of a low-refractive-index dielectric having a lower refractive index than that of the first nano-posts NP1, and arranged between the first nano-posts NP1 (e.g., the dielectric layer DL1 may extend between immediately adjacent first nano-posts NP1 in the horizontal direction that extends parallel to the upper surface 110S). The dielectric material of the first dielectric layer DL1 may include, for example, air or SiO₂. The diameters of the first nano-posts NP1 may be different from each other. The intervals in the horizontal direction between the first nano-posts NP1 (e.g., between immediately adjacent first nano-posts NP1) may be different from each other.

In addition, the first meta-micro-lens array 151 may condense incident light regardless of wavelength, and may also change the phase of the incident light according to the wavelength of the incident light, and then condense the incident light. In some example embodiments, the first meta-micro-lens array 151 may be partitioned into a green light condensing region that condenses green light, a blue light condensing region that condenses blue light, and a red light condensing region that condenses red light.

The first meta-micro-lens array 151 may include the first nano-posts NP1 whose sizes, shapes, intervals, and/or arrangements are determined such that the first nano-posts NP1 are configured to separate and condense green light onto the first and fourth pixels 111 and 114, to separate and condense blue light onto the second pixels 112, and to separate and condense red light onto the third pixels 113. In addition, the thickness of the first meta-micro-lens array 151 in a third direction (the Z direction) may be similar to (e.g., equal to) the height of the first nano-posts NP1 in the third direction, and may be about 500 nm to about 1500 nm.

In order to design the first meta-micro-lens array 151 for color separation, the structures of green, blue, red, and infrared pixel corresponding regions may be improved or optimized while evaluating the performance of a plurality of candidate color separation lens arrays based on evaluation factors such as color separation spectrum, optical efficiency, or signal-to-noise ratio. For example, the structures of the green, blue, and red pixel corresponding regions may be improved or optimized by determining a target numerical value for each of a plurality of evaluation factors in advance and then reducing or minimizing the sum of the differences from the target numerical values for the evaluation factors. Alternatively, the structures of the green, blue, and red pixel corresponding regions may be improved or optimized by creating an indicator of performance for each evaluation factor, and increasing or maximizing a value representing the performance.

The first meta-micro-lens array 151 may further include a plurality of first etch stoppers ES1 arranged below the first nano-posts NP1, respectively. For example, the first meta-micro-lens array 151 may include a plurality of first etch stoppers ES1 below separate, respective first nano-posts NP1. Each first etch stopper ES1 may be arranged between the first nano-post NP1 corresponding thereto (e.g., a separate one of the first nano-posts NP1) and the spacer 140, to protect the spacer 140 from being damaged during a process of forming the first nano-posts NP1. The first etch stopper ES1 may include a transparent dielectric material that has a relatively high etch selectivity with respect to the spacer 140. For example, the first etch stopper ES1 may include at least one material selected from aluminum oxide (AlO), hafnium oxide (HfO), and silicon nitride (SiN). The first etch stopper ES1 has a thickness that allows it to perform a function of protecting a lower layer, i.e., the spacer 140, without impairing the optical characteristics of the first meta-micro-lens array 151. The thickness of the first etch stopper ES1 may be, for example, about 3 nm to about 50 nm, or about 5 nm to about 15 nm.

In addition, in order to reduce or minimize an increase in reflectivity due to the first etch stopper ES1, the first etch stopper ES1 may be arranged not to completely cover (e.g., not completely overlap in the Z direction, in direct contact or spaced apart from in the Z direction) the entire surface of the spacer 140. In other words, the first etch stopper ES1 may be arranged to cover (e.g., overlap in the Z direction, in direct contact or spaced apart from in the Z direction) only a limited portion of the upper surface of the spacer 140. For example, each first etch stopper ES1 is arranged only below the first nano-post NP1 corresponding thereto in the vertical direction (e.g., Z direction), and the first etch stoppers ES1 are spaced apart from each other in the horizontal direction (e.g., X and/or Y directions), such that the upper surface of the spacer 140 may be in direct contact with the lower surface of the first dielectric layer DL1 in regions between the first etch stoppers ES1 (e.g., between immediately adjacent first etch stoppers ES1 in the X and/or Y directions). Because the refractive index of the spacer 140 and the refractive index of the first dielectric layer DL1 are equal or substantially equal to each other, almost no reflection occurs (e.g., no reflection or substantially no reflection occurs) at an interface between the spacer 140 and the first dielectric layer DL1. Thus, by reducing or minimizing the total area of the first etch stoppers ES1, an increase in reflectivity at the interface between the spacer 140 and the first etch stopper ES1 may be minimized.

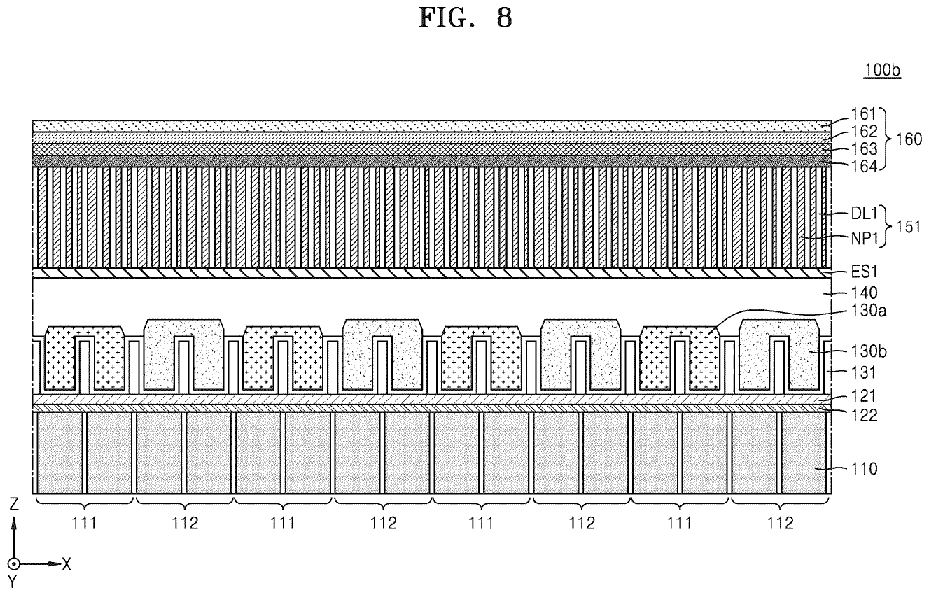

The image sensor 100a may include two or more upper anti-reflection layers 160 arranged on (e.g., directly or indirectly on) a light-incident surface (e.g., uppermost surface in FIG. 5) of the first meta-micro-lens array 151. FIG. 5 illustrates that the plurality of upper anti-reflection layers 160 include three layers, but as illustrated in FIG. 8, the plurality of upper anti-reflection layers 160 may include four layers, and although not illustrated in the drawings, may include four or more layers.

In some example embodiments, the plurality of upper anti-reflection layers 160 may include a first upper anti-reflection layer 161, a second upper anti-reflection layer 162, and a third upper anti-reflection layer 163. The first upper anti-reflection layer 161, the second upper anti-reflection layer 162, and the third upper anti-reflection layer 163 may be stacked to overlap each other in the vertical direction (the Z direction). The first upper anti-reflection layer 161 may be at the uppermost surface of the plurality of upper anti-reflection layers 160, the second upper anti-reflection layer 162 may be arranged on (e.g., directly below) the lower surface of the first upper anti-reflection layer 161, and the third upper anti-reflection layer 163 may be arranged on (e.g., directly below) the lower surface of the second upper anti-reflection layer 162. Thus, the vertical level of the third upper anti-reflection layer 163 may be the lowest. The refractive index of the plurality of upper anti-reflection layers 160 may be less than the refractive index of the first meta-micro-lens array 151 and greater than the refractive index of air. For example, the refractive indices of the plurality of upper anti-reflection layers 160 (e.g., the respective refractive index of each the plurality of upper anti-reflection layers 160) may be smaller than the refractive index of the first meta-micro-lens array 151 and greater than the refractive index of air. In some example embodiments, when the refractive index of the first meta-micro-lens array 151 is about 1.69, the refractive index of each of the first upper anti-reflection layer 161, the second upper anti-reflection layer 162, and the third upper anti-reflection layer 163 may be less than 1.69 and greater than 1. The plurality of upper anti-reflection layers 160 may each comprise at least one material of Al₂O₃, HfO, SiO₂, AlOC, AlON, AlOCN, Ta₂O₅, or TiO₂, or any combination thereof. For example, each of the first upper anti-reflection layer 161, the second upper anti-reflection layer 162, and the third upper anti-reflection layer 163 may independently include at least one material of Al₂O₃, HfO, SiO₂, AlOC, AlON, AlOCN, Ta₂O₅, or TiO₂, or any combination thereof.

The first upper anti-reflection layer 161, the second upper anti-reflection layer 162, and the third upper anti-reflection layer 163 may have refractive indices (e.g., respective refractive indices) that increase toward the first meta-micro-lens array 151 (e.g., increase with reduced distance of the given upper anti-reflection layer from the first meta-micro-lens array 151 in the Z direction). For example, each given upper anti-reflection layer of the plurality of upper anti-reflection layers 160 that is between the first meta-micro-lens array 151 and another upper anti-reflection layer of the plurality of upper anti-reflection layers 160 in the Z direction, such that the given upper anti-reflection layer is closer to the first meta-micro-lens array 151 than the other upper anti-reflection layer in the Z direction, may have a greater refractive index than the refractive index of the other upper anti-reflection layer. In some example embodiments, the refractive index of the second upper anti-reflection layer 162 may be less (e.g., smaller) than the refractive index of the third upper anti-reflection layer 163 and greater than the refractive index of the first upper anti-reflection layer 161. In some example embodiments, the refractive index of each of the plurality of upper anti-reflection layers 160 may linearly increase by about 0.2 for every 100 nm of the thickness of each of the plurality of upper anti-reflection layers 160 in the vertical direction (the Z direction). In some example embodiments, the refractive index of the plurality of upper anti-reflection layers 160 may linearly increase by about 0.2 for every 100 nm of a total thickness 160T of the plurality of upper anti-reflection layers 160 in the vertical direction (the Z direction) (e.g., between the uppermost surface 160u of the plurality of upper anti-reflection layers 160, which may be defined by the uppermost surface 161u of the first upper anti-reflection layer 161, and the lowermost surface 160r of the plurality of upper anti-reflection layers 160, which may be defined by the lowermost surface 163r of the third upper anti-reflection layer 163). That is, as the vertical level decreases through a total thickness 160T of the plurality of upper anti-reflection layers 160 in the Z direction (e.g., towards the upper surface 110S, from uppermost surface 160u to the lowermost surface 160r), the refractive index at the vertical level may increase. For example, as the vertical level decreases through the total thickness 160T of the plurality of upper anti-reflection layers 160 in the Z direction (e.g., from the uppermost surface 160u towards the upper surface 110S and/or to the lowermost surface 160r in the Z direction), the refractive index of a portion of the upper anti-reflection layers 160 at the vertical level may increase. In some example embodiments, the refractive index of a given individual upper anti-reflection layer (e.g., each upper anti-reflection layer of the plurality of upper anti-reflection layers 160) may be constant or substantially constant through a thickness of the given individual upper anti-reflection layer in the Z direction, and each pair of immediately adjacent (e.g., contacting) upper anti-reflection layers in the plurality of upper anti-reflection layers 160 (e.g., an overlying upper anti-reflection layer and an underlying upper anti-reflection layer that is directly beneath the overlying upper anti-reflection layer and in direct contact therewith) may be different such that the underlying immediately adjacent upper anti-reflection layer has a greater refraction index than the overlying immediately adjacent upper anti-reflection layer, such that the refraction index increases in step changes between separate (e.g., immediately adjacent) upper anti-reflection layers with reduced vertical level through the total thickness 160T of the plurality of upper anti-reflection layers 160 from uppermost surface 160u to the lowermost surface 160r. The step-changes in refractive index through the total thickness 160T of the plurality of upper anti-reflection layers in the Z direction (e.g., step changes in refractive index between separate (e.g., immediately adjacent) upper anti-reflection layers) may correspond to a linear increase in refractive index as a function of thickness from the uppermost surface 160u to the lowermost surface 160r through the plurality of upper anti-reflection layers 160 (e.g., an increase of about 0.2 for every 100 nm of the total thickness 160T of the plurality of upper anti-reflection layers 160 from the uppermost surface 160u to the lowermost surface 160r). In some example embodiments, a refractive index of a given individual upper anti-reflection layer may increase through a thickness of the given upper anti-reflection layer from the uppermost surface of the given individual upper anti-reflection layer to the lowermost surface of the given upper anti-reflective layer (e.g., towards the upper surface 110S), for example the refractive index may increase through a thickness of the given individual upper anti-reflection layer in a linear rate as a function of thickness in the Z direction. In some example embodiments, in a case in which the first upper anti-reflection layer 161 has a refractive index of about 1.22 and a thickness of 1,000 angstroms (Å), the second upper anti-reflection layer 162 may have a refractive index of about 1.35 and a thickness of 1,000 angstroms (Å). In some example embodiments, in a case in which the second upper anti-reflection layer 162 has a refractive index of about 1.35 and a thickness of 1,000 angstroms (Å), the third upper anti-reflection layer 163 may have a refractive index of about 1.46 and a thickness of 1,000 angstroms (Å).

In the upper anti-reflection layers 160, the refractive index increases as the vertical level decreases (e.g., towards the upper surface 110S in the Z direction), and thus, when incident light entering the first meta-micro-lens array 151 (e.g., incident light that is incident on the first meta-micro-lens array 151 through the plurality of upper anti-reflection layers 160) is reflected from the light-incident surface (e.g., uppermost surface 151u in FIG. 5) of the first meta-micro-lens array 151, a path of travel of the reflected light is formed from a region with a higher refractive index to a region with a lower refractive index. Thus, because the reflected incident light travels from an upper anti-reflection layer with a higher refractive index (e.g., third upper anti-reflection layer 163) to an upper anti-reflection layer with a lower refractive index (e.g., second upper anti-reflection layer 162), total reflection or refraction occurs at a boundary between the upper anti-reflection layers (e.g., at the boundary or interface between the second and third upper anti-reflection layers 162 and 163), resulting in a low frequency of reflection (e.g., a reduced amount of reflection of incident light out of the image sensor 100 from the first meta-micro-lens array 151 through an entire thickness of the plurality of upper anti-reflection layers 160 in the Z direction), and accordingly, the intensity of the reflected light (e.g., intensity of incident light that is reflected out of the image sensor 100a through the uppermost surface 161u of the first upper anti-reflection layer 161, also referred to herein as the light-incident surface of the first upper anti-reflection layer 161 and/or the light-incident surface of the plurality of upper anti-reflection layers 160) decreases. In some example embodiments, when incident light is reflected from the third upper anti-reflection layer 163 to the second upper anti-reflection layer 162, and the angle of incidence of the reflected incident light is greater than a critical angle determined by the refractive index of each of the third upper anti-reflection layer 163 and the second upper anti-reflection layer 162, the incident light undergoes total reflection at a boundary between the third upper anti-reflection layer 163 and the second upper anti-reflection layer 162 (e.g., total reflection of the incident light back into the third upper anti-reflection layer 163 from the lower surface of the second upper anti-reflection layer 162). The path of the incident light described above is the same for a boundary between the first upper anti-reflection layer 161 and the second upper anti-reflection layer 162, and may also be applied equally to a boundary between the first meta-micro-lens array 151 and the third upper anti-reflection layer 163. As a result, the plurality of upper anti-reflection layers 160, also referred to herein as an anti-reflection film, may cause the image sensor 100a to have reduced, minimized, or prevented reflectance at a light-incident surface of the first meta-micro-lens array 151 (e.g., at the uppermost surface 151u). As a result, the image sensor 100a (which may be included in and/or may be the image sensor 100) may have improved light sensitivity, improved light sensing and/or image generating performance, improved power consumption efficiency so as to sense light and/or generate images corresponding to the sensed light with reduced power consumption and/or to reduce power consumption without compromising light sensing and/or image generation performance, any combination thereof, or the like.

The thicknesses of the first upper anti-reflection layer 161, the second upper anti-reflection layer 162, and the third upper anti-reflection layer 163 may be different from each other. The thickness of each of the first upper anti-reflection layer 161, the second upper anti-reflection layer 162, and the third upper anti-reflection layer 163 may each be about 100 angstroms (Å) to about 2,000 angstroms (Å).

FIG. 6 is a plan view illustrating an arrangement of pixels in a pixel array according to some example embodiments.

FIG. 6 illustrates an arrangement of pixels in the pixel array 10 of the image sensor 100, which has a Bayer pattern arrangement as illustrated in FIG. 2. This arrangement is for sensing incident light in unit patterns such as a Bayer pattern. For example, the first pixels 111 and the fourth pixels 114 may be green pixels configured to sense green light, the second pixels 112 may be blue pixels configured to sense blue light, and the third pixels 113 may be red pixels configured to sense red light. In a unit pattern in a 2×2 array form, the first pixel 111 and the fourth pixel 114, which are green pixels, may be arranged in one diagonal direction, and the second pixel 112 and the third pixel 113, which are a blue pixel and a red pixel, respectively, may be arranged in the opposite diagonal direction.

Referring back to FIG. 5, the spacer 140 is arranged between the sensor substrate 110 and the first meta-micro-lens array 151 to be configured to maintain a constant interval (e.g., a constant spacing in the Z direction) between the sensor substrate 110 and the first meta-micro-lens array 151. The spacer 140 (which may be referred to herein interchangeably as a transparent spacer) may include a dielectric material transparent to visible light, for example, SiO₂, or silanol-based glass (e.g., siloxane-based spin on glass (SOG)), which has a lower refractive index than those (e.g., the respective refractive indices) of the first nano-posts NP1 of the first meta-micro-lens array 151, and a low absorption coefficient in the visible light band. The thickness of the spacer 140 (e.g., in the Z direction) may be determined based on a focal length for light condensed by the first meta-micro-lens array 151, and may be selected, for example, within a range of about 0.5 times to about 1.5 times a focal length for light of a reference wavelength λ₀.

Assuming that the reference wavelength λ₀ is 540 nm, which is green light, the pitch of the pixels 111, 112, 113, and 114 (e.g., in the X and/or Y directions) is 0.8 μm, and a refractive index n of the spacer 140 at a wavelength of 540 nm is 1.46, a focal length f for green light, i.e., the distance (e.g., in the Z direction) between the lower surface of the first meta-micro-lens array 151 and a point where the green light converges, may be about 1.64 μm, and the thickness of the spacer 140 (e.g., in the Z direction) may be selected within a range of about 0.82 μm to about 2.46 μm.

The first meta-micro-lens array 151 may include the first nano-posts NP1 that are supported by the spacer 140, have a high refractive index, and are configured to change the phase of incident light, and the first dielectric layer DL1 that is formed of a low-refractive-index dielectric having a lower refractive index than that of the first nano-posts NP1, and arranged between the first nano-posts NP1 (e.g., between immediately adjacent first nano-posts NP1 in the horizontal direction). The dielectric material of the first dielectric layer DL1 may include, for example, air or SiO₂.

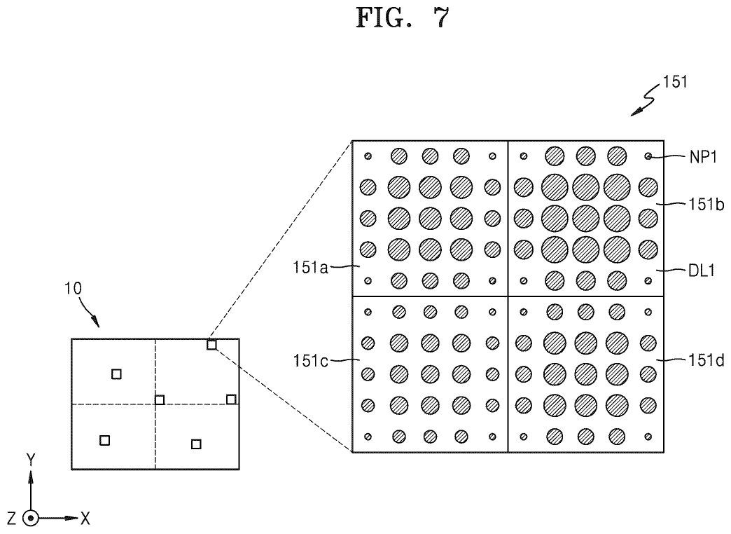

FIG. 7 is a plan view illustrating a configuration of a meta-micro-lens array included in an image sensor, according to some example embodiments.

Referring to FIG. 7, in some example embodiments, a plurality of first meta-micro-lens arrays 151 arranged in the pixel array 10 may include first to fourth lenses 151a, 151b, 151c, and 151d to only condense incident light onto the first to fourth pixels 111, 112, 113, and 114 without color separation. For example, the first to fourth lenses 151a, 151b, 151c, and 151d may simply condense the incident light onto the corresponding first to fourth pixels 111, 112, 113, and 114, respectively, and color separation may occur in the color filters 130a and 130b. In addition, in some example embodiments, the first meta-micro-lens array 151 may condense light and may also change the phase of the light according to the wavelength of the light, and then condense the light. In some example embodiments, the phase of light of a first wavelength may be changed and then the light of the first wavelength may be condensed onto each first pixel 111, the phase of light of a second wavelength may be changed and then the light of the second wavelength may be condensed onto each second pixel 112, the phase of light of a third wavelength may be changed and then the light of the third wavelength may be condensed onto each third pixel 113, and the phase of light of a fourth wavelength may be changed and then the light of the fourth wavelength may be condensed onto each fourth pixel 114. Apart from wavelength-specific condensation by the first meta-micro-lens array 151, color separation may occur independently and redundantly in the color filters 130a and 130b. A case in which only condensation is performed will be additionally described below with reference to FIG. 7. For condensing incident light, a plurality of first nano-posts NP1 in each of the first to fourth lenses 151a, 151b, 151c, and 151d may be arranged symmetrically in the first direction (the X direction) and the second direction (the Y direction) with respect to the center of each of the first to fourth lenses 151a, 151b, 151c, and 151d. In particular, the first nano-posts NP1 arranged in a central region of each of the first to fourth lenses 151a, 151b, 151c, and 151d may have the largest diameter such that the largest phase delay occurs in the central region of each of the first to fourth lenses 151a, 151b, 151c, and 151d, and the diameters of the first nano-posts NP1 may gradually decrease from the central region of each of the first to fourth lenses 151a, 151b, 151c, and 151d.

In the first meta-micro-lens array 151 illustrated in FIG. 7, the first to fourth lenses 151a, 151b, 151c, and 151d may operate as respective lenses for all of first to fourth photosensitive cells of the corresponding first to fourth pixels 111, 112, 113, and 114, respectively. In some example embodiments, the first meta-micro-lens array 151 may be configured to form a focal point on each of the first to fourth photosensitive cells of the first to fourth pixels 111, 112, 113, and 114.

Meanwhile, the spacer 140 may provide a flat (e.g., planar or substantially planar) surface such that the first meta-micro-lens array 151 may be formed on the color filters 130a and 130b. In addition, the spacer 140 may serve as a spacer that provides a distance (e.g., in the Z direction) between the sensor substrate 110 and the first meta-micro-lens array 151, together with the color filters 130a and 130b. The distance (e.g., in the Z direction) between the sensor substrate 110 and the first meta-micro-lens array 151 may be determined by the focal length of the first meta-micro-lens array 151. For example, the thickness (e.g., in the Z direction) of the spacer 140 and the thicknesses of the color filters 130a and 130b may be equal to the focal length of the first meta-micro-lens array 151. Accordingly, light condensed by the first meta-micro-lens array 151 may be focused onto the sensor substrate 110. When the focal length of the first meta-micro-lens array 151 is sufficiently short, the spacer 140 may be omitted.

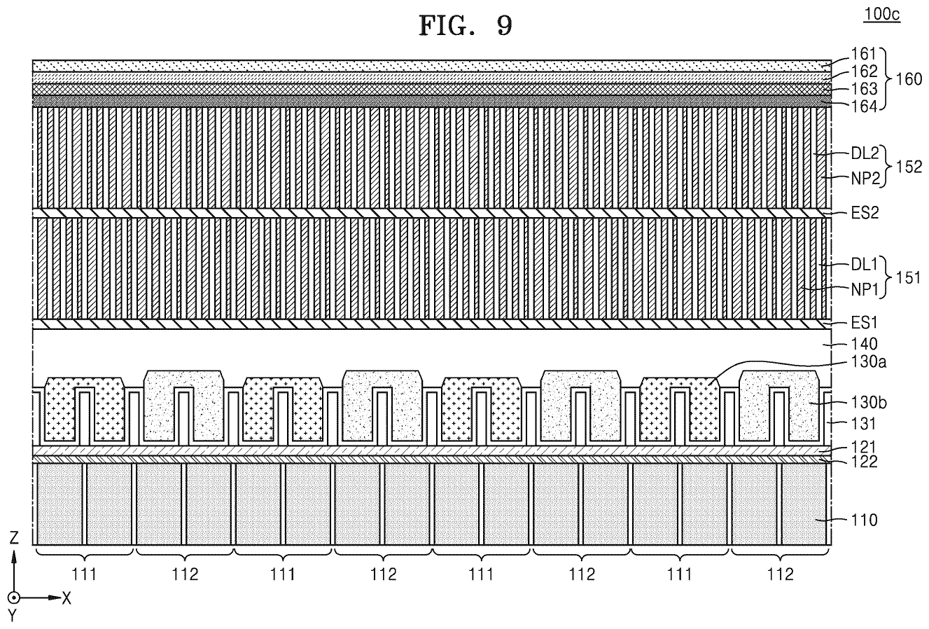

FIGS. 8 and 9 are cross-sectional views of image sensors according to some example embodiments. FIG. 8 illustrates an image sensor 100b which may be included in and/or may be the image sensor 100 described above with reference to FIGS. 1 to 4 according to some example embodiments. FIG. 9 illustrates an image sensor 100c which may be included in and/or may be the image sensor 100 described above with reference to FIGS. 1 to 4 according to some example embodiments.

With reference to FIG. 8 and FIG. 9 together with FIG. 5, the differences from FIG. 5 will be mainly described.

Referring to FIG. 8, upper anti-reflection layers 160 included in an image sensor 100b may include four layers. The upper anti-reflection layers 160 may further include a fourth upper anti-reflection layer 164. However, the number (e.g., quantity) of layers of the upper anti-reflection layers 160 is not limited thereto and may be four or more. The fourth upper anti-reflection layer 164 may be arranged below the third upper anti-reflection layer 163. The refractive index of the fourth upper anti-reflection layer 164 may be greater than the refractive index of the third upper anti-reflection layer 163 and less than the refractive index of the first meta-micro-lens array 151. Even in the case of FIG. 8, the refractive index of each of the plurality of upper anti-reflection layers 160 may linearly increase by about 0.2 for every 100 nm of the thickness of each of the plurality of upper anti-reflection layers 160 in the vertical direction (the Z direction). That is, as the vertical level decreases (e.g., distance of a portion of the upper anti-reflection layers 160 from the upper surface 110S in the Z direction decreases), the refractive index may increase. In some example embodiments, in a case in which the third upper anti-reflection layer 163 has a refractive index of about 1.22 and a thickness of 1,000 angstroms (Å), the fourth upper anti-reflection layer 164 may have a refractive index of about 1.67 and a thickness of 1,000 angstroms (Å).

Referring to FIG. 9, an image sensor 100c may include two meta-micro-lens arrays. In some example embodiments, the image sensor 100c may include a first meta-micro-lens array 151 and a second meta-micro-lens array 152. The second meta-micro-lens array 152 may be arranged above the first meta-micro-lens array 151. That is, light incident on the image sensor 100c may first pass through the second meta-micro-lens array 152 and then pass through the first meta-micro-lens array 151. The thicknesses of the first meta-micro-lens array 151 and the second meta-micro-lens array 152 may be substantially equal to each other. The second meta-micro-lens array 152 may include second nano-posts NP2 that have a high refractive index and change the phase of incident light, and a second dielectric layer DL2 that is arranged between the second nano-posts NP2, and formed of a low-refractive-index dielectric having a lower refractive index than that of the second nano-posts NP2. The second nano-posts NP2 and the second dielectric layer DL2 may be made of the same or substantially the same materials as the first nano-posts NP1 and the first dielectric layer DL1. In some example embodiments, the positions of the second nano-posts NP2 in the horizontal direction may be different from the positions of the plurality of first nano-posts NP1 in the horizontal direction, for example such that the first nano-posts NP1 may at least partially or entirely not overlap the second nano-posts NP2, for example such that the first nano-posts NP1 may be at least partially or entirely exposed from the second nano-posts NP2 in the Z direction and the second nano-posts NP2 may be at least partially or entirely exposed from the first nano-posts NP1 in the Z direction. That is, on the lower side of the second nano-posts NP2, the first dielectric layer DL1, instead of the same first nano-posts NP1, may be arranged (e.g., the lower sides of respective second nano-posts NP2 may overlap the first dielectric layer DL1 in the Z direction). The second meta-micro-lens array 152 may be capable of not only simple light condensation but also color separation, like the first meta-micro-lens array 151. Each of the first meta-micro-lens array 151 and the second meta-micro-lens array 152 included in the image sensor 100c may be capable of only condensing light or may be capable of changing the phase of light of a first wavelength and then condensing the light of the first wavelength onto each first pixel, and changing the phase of light of a second wavelength and then condensing the light of the second wavelength onto each second pixel.

In some example embodiments, both the first meta-micro-lens array 151 and the second meta-micro-lens array 152 may be capable of only condensing incident light. In some example embodiments, both the first meta-micro-lens array 151 and the second meta-micro-lens array 152 may be capable of changing the phase of incident light according to the wavelength of the incident light, and then condensing the incident light onto each pixel corresponding to the wavelength of the incident light. In some example embodiments, the first meta-micro-lens array 151 may be capable of only condensing all incident light, and the second meta-micro-lens array 152 may be capable of changing the phase of incident light according to the wavelength for the incident light, and then condensing the incident light onto each pixel corresponding to the wavelength of the incident light. In some example embodiments, the first meta-micro-lens array 151 may be capable of changing the phase of incident light according to the wavelength of the incident light, and then condensing the incident light onto each pixel corresponding to the wavelength of the incident light, and the second meta-micro-lens array 152 may be capable of only condensing all incident light.

The image sensor 100c may further include a second etch stopper ES2 arranged between the first meta-micro-lens array 151 and the second meta-micro-lens array 152. The second etch stopper ES2 may be substantially the same as the first etch stopper ES1.

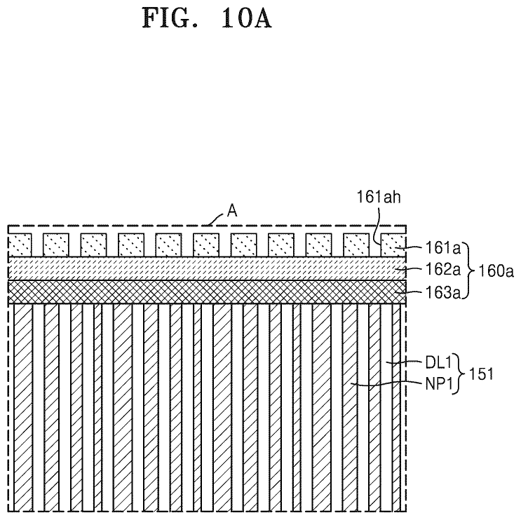

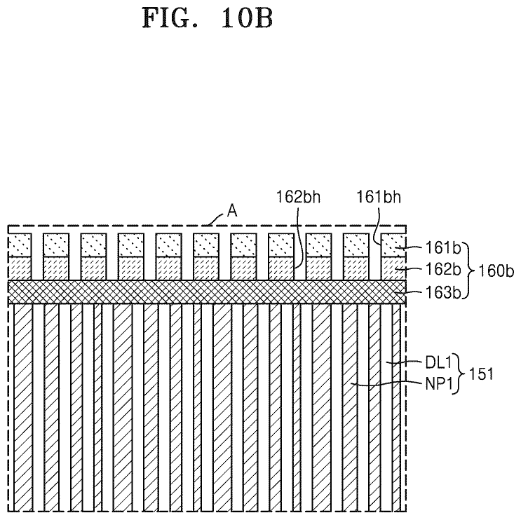

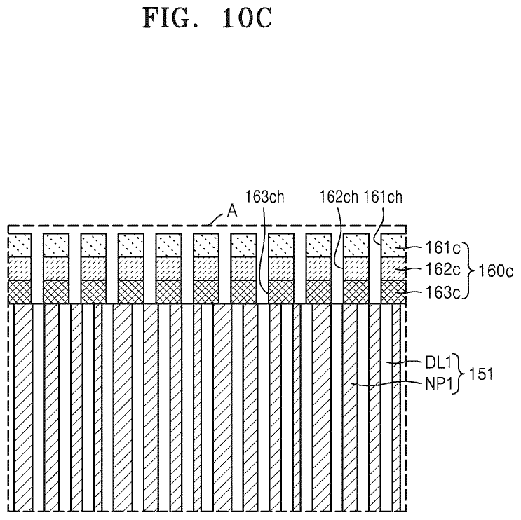

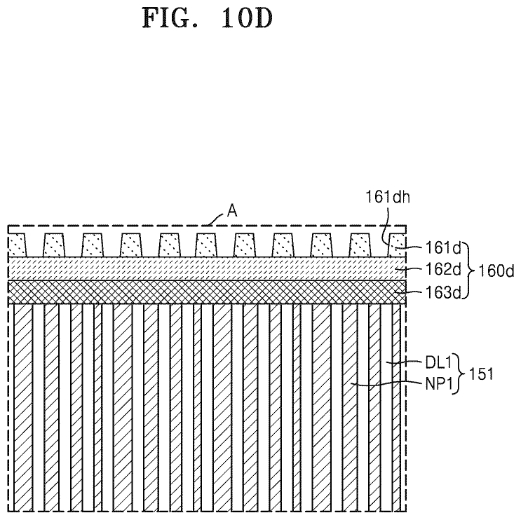

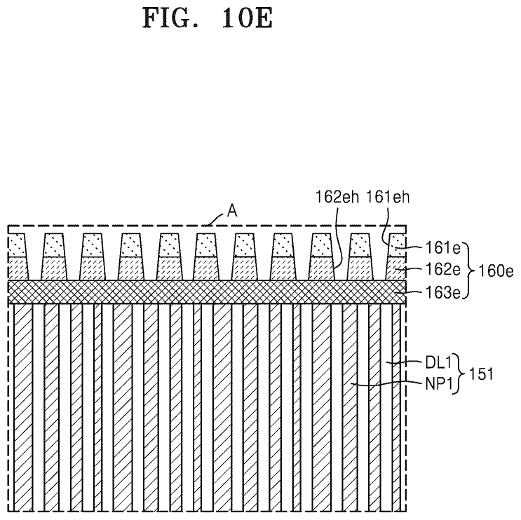

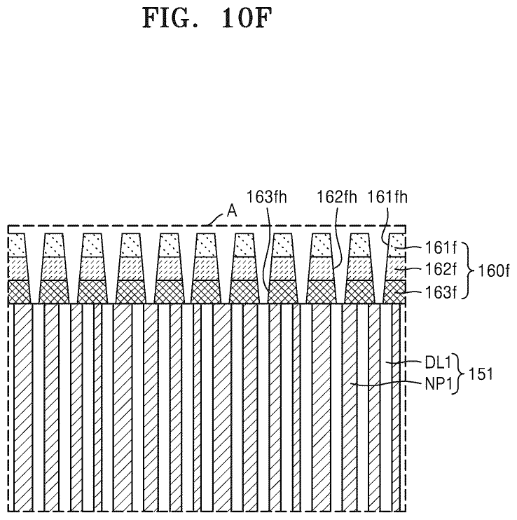

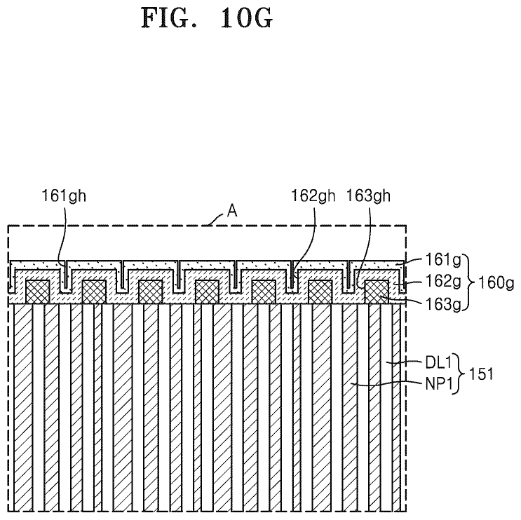

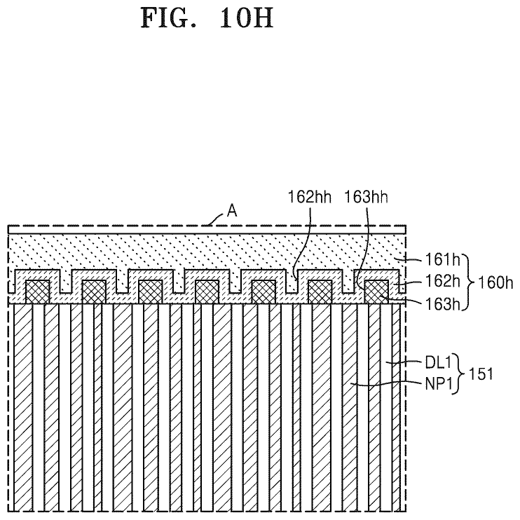

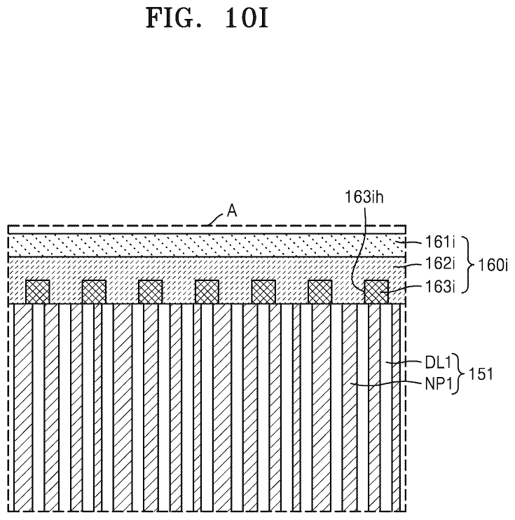

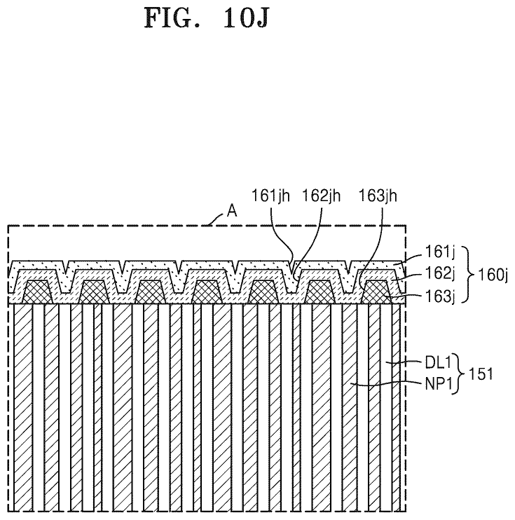

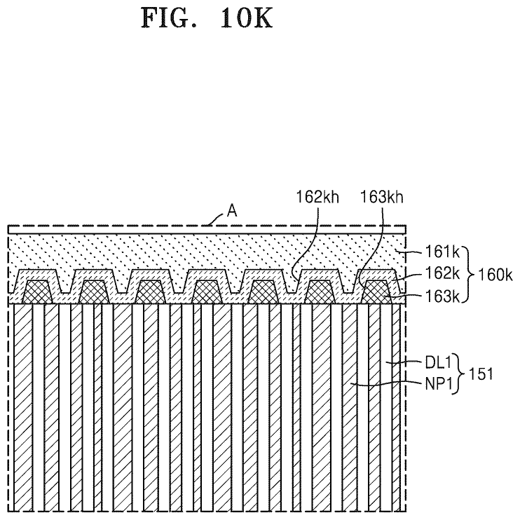

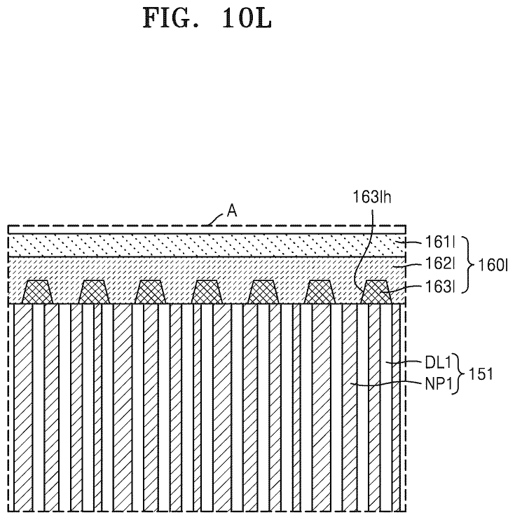

FIGS. 10A to 10L are enlarged views of region A of FIG. 5 according to some example embodiments.

Referring to FIG. 10A, upper anti-reflection layers 160a may be arranged on (e.g., directly or indirectly on) the upper surface of the first meta-micro-lens array 151. However, example embodiments are not limited thereto, and the upper anti-reflection layers 160a may also be arranged on the upper surface of the second meta-micro-lens array. The upper anti-reflection layers 160a may include a first upper anti-reflection layer 161a, a second upper anti-reflection layer 162a, and a third upper anti-reflection layer 163a. Holes 161ah may be formed in the first upper anti-reflection layer 161a. The holes may be exposed to the outside. The holes 161ah formed in the first upper anti-reflection layer 161a may be arranged periodically (e.g., may be spaced apart according to a periodic interval) in two dimensions. The cross-sectional areas of the holes 161ah formed in the first upper anti-reflection layer 161a in the horizontal direction may be constant. No holes may be formed in the second upper anti-reflection layer 162a and the third upper anti-reflection layer 163a. The levels of the uppermost surfaces of the first upper anti-reflection layer 161a, the second upper anti-reflection layer 162a, and the third upper anti-reflection layer 163a may be equal to each other (e.g., the upper surfaces of the first, second and third upper anti-reflection layers 161a, 162a, and 163a may be planar or substantially planar in the X and Y directions).

Referring to FIG. 10B, upper anti-reflection layers 160b may be arranged on the upper surface of the first meta-micro-lens array 151. The upper anti-reflection layers 160b may include a first upper anti-reflection layer 161b, a second upper anti-reflection layer 162b, and a third upper anti-reflection layer 163b. Holes 161bh and 162bh may be formed in the first upper anti-reflection layer 161b and the second upper anti-reflection layer 162b. The holes 161bh and 162bh may be exposed to the outside. The widths and positions of the holes 161bh and 162bh formed in the first upper anti-reflection layer 161b and the second upper anti-reflection layer 162b in the horizontal direction may be identical to each other, respectively, and the holes may be formed sequentially or simultaneously. The holes 161bh may overlap separate, respective holes 162bh in the Z direction. The holes 161bh and 162bh formed in the first upper anti-reflection layer 161b and the second upper anti-reflection layer 162b may be arranged periodically in two dimensions. No holes may be formed in the third upper anti-reflection layer 163b.

Referring to FIG. 10C, upper anti-reflection layers 160c may be arranged on the upper surface of the first meta-micro-lens array 151. The upper anti-reflection layers 160c may include a first upper anti-reflection layer 161c, a second upper anti-reflection layer 162c, and a third upper anti-reflection layer 163c. Holes 161ch, 162ch, and 163ch may be formed in the first upper anti-reflection layer 161c, the second upper anti-reflection layer 162c, and the third upper anti-reflection layer 163c. The holes 161ch, 162ch, and 163ch may be exposed to the outside. The widths and positions of the holes 161ch, 162ch, and 163ch formed in the first upper anti-reflection layer 161c, the second upper anti-reflection layer 162c, and the third upper anti-reflection layer 163c in the horizontal direction may be identical to each other, respectively, and the holes 161ch, 162ch, and 163ch may be formed sequentially or simultaneously. The holes 161ch may overlap separate, respective holes 162ch and 163ch in the Z direction. The holes 161ch, 162ch, and 163ch formed in the first upper anti-reflection layer 161c, the second upper anti-reflection layer 162c, and the third upper anti-reflection layer 163c may be arranged periodically in two dimensions. Due to the holes 161ch, 162ch, and 163ch formed in the first upper anti-reflection layer 161c, the second upper anti-reflection layer 162c, and the third upper anti-reflection layer 163c, a portion of the upper surface of the first meta-micro-lens array 151 may be exposed to the outside.

Referring to FIG. 10D, upper anti-reflection layers 160d may be arranged on the upper surface of the first meta-micro-lens array 151. The upper anti-reflection layers 160d may include a first upper anti-reflection layer 161d, a second upper anti-reflection layer 162d, and a third upper anti-reflection layer 163d. Holes 161dh may be formed in the first upper anti-reflection layer 161d. The holes may be exposed to the outside. The cross-sectional area of each of the holes 161dh in the horizontal direction may have a tapered shape that narrows toward the first meta-micro-lens array 151. The holes 161dh formed in the first upper anti-reflection layer 161d may be arranged periodically in two dimensions. No holes may be formed in the second upper anti-reflection layer 162d and the third upper anti-reflection layer 163d. The levels of the uppermost surfaces of the first upper anti-reflection layer 161d, the second upper anti-reflection layer 162d, and the third upper anti-reflection layer 163d may be equal to each other (e.g., the upper surfaces of the first, second and third upper anti-reflection layers 161d, 162d, and 163d may be planar or substantially planar in the X and Y directions).

Referring to FIG. 10E, upper anti-reflection layers 160e may be arranged on the upper surface of the first meta-micro-lens array 151. The upper anti-reflection layers 160e may include a first upper anti-reflection layer 161e, a second upper anti-reflection layer 162e, and a third upper anti-reflection layer 163e. Holes 161eh and 162eh may be formed in the first upper anti-reflection layer 161e and the second upper anti-reflection layer 162e. The holes 161eh and 162eh may be exposed to the outside. The cross-sectional area of each of the plurality of holes 161eh and 162eh in the horizontal direction may have a tapered shape that narrows toward the first meta-micro-lens array 151. Sidewalls of the holes 161eh and 162eh formed in the first upper anti-reflection layer 161e and the second upper anti-reflection layer 162e may be continuously formed (e.g., such that there is no step change in cross sectional area or shape between the holes 161eh and 162eh at the interface between the bottom of the hole 161eh and the top of the hole 162eh, for example such that the holes 161eh and 162eh collectively define a single hole having a continuously tapering shape without step changes in width while penetrating through the first and second upper anti-reflection layers 161e and 162e), and may be formed sequentially or simultaneously. The holes 161eh and 162eh formed in the first upper anti-reflection layer 161e and the second upper anti-reflection layer 162e may be arranged periodically in two dimensions. No holes may be formed in the third upper anti-reflection layer 163e.

Referring to FIG. 10F, upper anti-reflection layers 160f may be arranged on the upper surface of the first meta-micro-lens array 151. The upper anti-reflection layers 160f may include a first upper anti-reflection layer 161f, a second upper anti-reflection layer 162f, and a third upper anti-reflection layer 163f. Holes 161fh, 162fh, and 163fh may be formed in the first upper anti-reflection layer 161f, the second upper anti-reflection layer 162f, and the third upper anti-reflection layer 163f. The holes 161fh, 162fh, and 163fh may be exposed to the outside. The cross-sectional area of each of the plurality of holes 161fh, 162fh, and 163fh in the horizontal direction may have a tapered shape that narrows toward the first meta-micro-lens array 151. Sidewalls of the holes 161fh, 162fh, and 163fh formed in the first upper anti-reflection layer 161f, the second upper anti-reflection layer 162f, and the third upper anti-reflection layer 163f may be continuously formed (e.g., such that there is no step change in cross sectional area or shape between the holes 161fh and 162fh at the interface between the bottom of the hole 161fh and the top of the hole 162fh, and there is no step change in cross sectional area or shape between the holes 162fh and 163fh at the interface between the bottom of the hole 162fh and the top of the hole 163fh, for example such that the holes 161fh, 162fh, and 163fh collectively define a single hole having a continuously tapering shape without step changes in width while penetrating through the first to third upper anti-reflection layers 161f to 163f), and may be formed sequentially or simultaneously. The holes 161fh, 162fh, and 163fh formed in the first upper anti-reflection layer 161f, the second upper anti-reflection layer 162f, and the third upper anti-reflection layer 163f may be arranged periodically in two dimensions. Due to the holes 161fh, 162fh, and 163fh formed in the first upper anti-reflection layer 161f, the second upper anti-reflection layer 162f, and the third upper anti-reflection layer 163f, a portion of the upper surface of the first meta-micro-lens array 151 may be exposed to the outside (e.g., through the holes).

Referring to FIG. 10G, upper anti-reflection layers 160g may be arranged on the upper surface of the first meta-micro-lens array 151. The upper anti-reflection layers 160g may include a first upper anti-reflection layer 161g, a second upper anti-reflection layer 162g, and a third upper anti-reflection layer 163g. The third upper anti-reflection layer 163g arranged at the lowest position may include a plurality of holes 163gh that are periodically arranged in two dimensions. The second upper anti-reflection layer 162g arranged on the third upper anti-reflection layer 163g may cover the outer surface of the third upper anti-reflection layer 163g. The first upper anti-reflection layer 161g arranged on the second upper anti-reflection layer 162g may cover the outer surface of the second upper anti-reflection layer 162g. The second upper anti-reflection layer 162g may be formed to fill the holes 163gh formed in the third upper anti-reflection layer 163g. The second upper anti-reflection layer 162g may include a plurality of holes 162gh that are arranged simultaneously and periodically in two dimensions. The first upper anti-reflection layer 161g may be formed to fill the holes 162gh formed in the second upper anti-reflection layer 162g. The first upper anti-reflection layer 161g may include a plurality of holes 161gh that are arranged simultaneously and periodically in two dimensions. The cross-sectional area of the holes 163gh formed in the third upper anti-reflection layer 163g in the horizontal direction may be greater than the horizontal cross-sectional area of the holes 162gh formed in the second upper anti-reflection layer 162g in the horizontal direction. The cross-sectional area of the holes 162gh formed in the second upper anti-reflection layer 162g in the horizontal direction may be greater than the horizontal cross-sectional area of the holes 161gh formed in the first upper anti-reflection layer 161g in the horizontal direction. The holes 161gh formed in the first upper anti-reflection layer 161g and the second upper anti-reflection layer 162g may not be exposed to the outside, but the holes 163gh formed in the third upper anti-reflection layer 163g may be exposed to the outside.

Referring to FIG. 10H, upper anti-reflection layers 160h may be arranged on the upper surface of the first meta-micro-lens array 151. The upper anti-reflection layers 160h may include a first upper anti-reflection layer 161h, a second upper anti-reflection layer 162h, and a third upper anti-reflection layer 163h. The third upper anti-reflection layer 163h arranged at the lowest position may include a plurality of holes 163hh that are periodically arranged in two dimensions. The second upper anti-reflection layer 162h arranged on the third upper anti-reflection layer 163h may cover the outer surface of the third upper anti-reflection layer 163h. The first upper anti-reflection layer 161h arranged on the second upper anti-reflection layer 162h may cover the outer surface of the second upper anti-reflection layer 162h. The second upper anti-reflection layer 162h may be formed to fill the holes 163hh formed in the third upper anti-reflection layer 163h. The second upper anti-reflection layer 162h may include a plurality of holes 162hh that are arranged simultaneously and periodically in two dimensions. The first upper anti-reflection layer 161h may be formed to fill the holes 162hh formed in the second upper anti-reflection layer 162h. The vertical level of the top surface of the first upper anti-reflection layer 161h may be constant (e.g., the upper surface of the first upper anti-reflection layer 161h may be planar or substantially planar in the X and Y directions). The cross-sectional area of the holes 163hh formed in the third upper anti-reflection layer 163h in the horizontal direction may be greater than the horizontal cross-sectional area of the holes 162hh formed in the second upper anti-reflection layer 162h in the horizontal direction.

Referring to FIG. 10I, upper anti-reflection layers 160i may be arranged on the upper surface of the first meta-micro-lens array 151. The upper anti-reflection layers 160i may include a first upper anti-reflection layer 161i, a second upper anti-reflection layer 162i, and a third upper anti-reflection layer 163i. The third upper anti-reflection layer 163i arranged at the lowest position may include a plurality of holes 163ih that are periodically arranged in two dimensions. The second upper anti-reflection layer 162i arranged on the third upper anti-reflection layer 163i may cover the outer surface of the third upper anti-reflection layer 163i. The first upper anti-reflection layer 161i arranged on the second upper anti-reflection layer 162i may cover the outer surface of the second upper anti-reflection layer 162i. The second upper anti-reflection layer 162i may be formed to fill the holes 163ih formed in the third upper anti-reflection layer 163i. The vertical level of the uppermost surface of each of the first upper anti-reflection layer 161i and the second upper anti-reflection layer 162i may be constant (e.g., may be planar or substantially planar).

Referring to FIG. 10J, upper anti-reflection layers 160j may be arranged on the upper surface of the first meta-micro-lens array 151. The upper anti-reflection layers 160j may include a first upper anti-reflection layer 161j, a second upper anti-reflection layer 162j, and a third upper anti-reflection layer 163j. The third upper anti-reflection layer 163j arranged at the lowest position may include a plurality of holes 163jh that are periodically arranged in two dimensions. The cross-sectional area of the third upper anti-reflection layer 163j in the horizontal direction may have a shape that widens toward the first meta-micro-lens array 151. The second upper anti-reflection layer 162j arranged on the third upper anti-reflection layer 163j may cover the outer surface of the third upper anti-reflection layer 163j. The first upper anti-reflection layer 161j arranged on the second upper anti-reflection layer 162j may cover the outer surface of the second upper anti-reflection layer 162j. The second upper anti-reflection layer 162j may be formed to fill the holes 163jh formed in the third upper anti-reflection layer 163j. The second upper anti-reflection layer 162j may include a plurality of holes 162jh that are arranged simultaneously and periodically in two dimensions. The first upper anti-reflection layer 161j may be formed to fill the holes 162jh formed in the second upper anti-reflection layer 162j. The first upper anti-reflection layer 161j may include a plurality of holes 161jh that are arranged simultaneously and periodically in two dimensions. The cross-sectional area of the holes 163jh formed in the third upper anti-reflection layer 163j in the horizontal direction may be greater than the horizontal cross-sectional area of the holes 162jh formed in the second upper anti-reflection layer 162j in the horizontal direction. The cross-sectional area of the holes 162jh formed in the second upper anti-reflection layer 162j in the horizontal direction may be greater than the horizontal cross-sectional area of the holes 161jh formed in the first upper anti-reflection layer 161j in the horizontal direction. The holes 163jh and 162jh formed in the third upper anti-reflection layer 163j and the second upper anti-reflection layer 162j may not be exposed to the outside, but the holes 161jh formed in the first upper anti-reflection layer 161j may be exposed to the outside.

Referring to FIG. 10K, upper anti-reflection layers 160k may be arranged on the upper surface of the first meta-micro-lens array 151. The upper anti-reflection layers 160k may include a first upper anti-reflection layer 161k, a second upper anti-reflection layer 162k, and a third upper anti-reflection layer 163k. The third upper anti-reflection layer 163k arranged at the lowest position may include a plurality of holes 163kh that are periodically arranged in two dimensions. The cross-sectional area of the third upper anti-reflection layer 163k in the horizontal direction may have a shape that widens toward the first meta-micro-lens array 151. The second upper anti-reflection layer 162k arranged on the third upper anti-reflection layer 163k may cover the outer surface of the third upper anti-reflection layer 163k. The first upper anti-reflection layer 161k arranged on the second upper anti-reflection layer 162k may cover the outer surface of the second upper anti-reflection layer 162k. The second upper anti-reflection layer 162k may be formed to fill the holes 163kh formed in the third upper anti-reflection layer 163k. The second upper anti-reflection layer 162k may include a plurality of holes 162jh that are arranged simultaneously and periodically in two dimensions. The first upper anti-reflection layer 161k may be formed to fill the holes 162kh formed in the second upper anti-reflection layer 162k. The vertical level of the top surface of the first upper anti-reflection layer 161k may be constant, for example to be planar or substantially planar. The cross-sectional area of the holes formed in the third upper anti-reflection layer 163k in the horizontal direction may be greater than the horizontal cross-sectional area of the holes 162kh formed in the second upper anti-reflection layer 162k in the horizontal direction.

Referring to FIG. 10L, upper anti-reflection layers 160l may be arranged on the upper surface of the first meta-micro-lens array 151. The upper anti-reflection layers 160l may include a first upper anti-reflection layer 161l, a second upper anti-reflection layer 162l, and a third upper anti-reflection layer 163l. The third upper anti-reflection layer 163l arranged at the lowest position may include a plurality of holes 163lh that are periodically arranged in two dimensions. The cross-sectional area of the third upper anti-reflection layer 163l in the horizontal direction may have a shape that widens toward the first meta-micro-lens array 151. The second upper anti-reflection layer 162l arranged on the third upper anti-reflection layer 163l may cover the outer surface of the third upper anti-reflection layer 163l. The first upper anti-reflection layer 161l arranged on the second upper anti-reflection layer 162l may cover the outer surface of the second upper anti-reflection layer 162l. The second upper anti-reflection layer 162l may be formed to fill the holes 163lh formed in the third upper anti-reflection layer 163l. The vertical level of the uppermost surface of each of the first upper anti-reflection layer 161l and the second upper anti-reflection layer 162l may be constant, for example such that the uppermost surface of each of the first upper anti-reflection layer 161l and the second upper anti-reflection layer 162l may be planar or substantially planar.

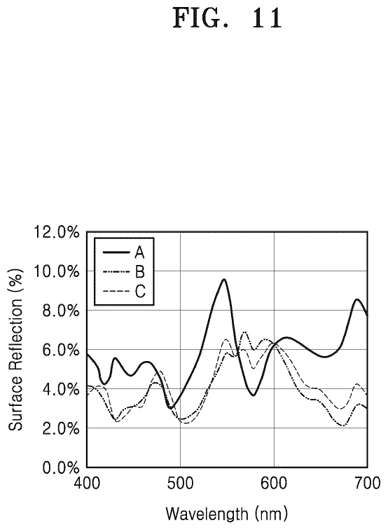

FIG. 11 is a graph showing reflectance according to wavelengths of image sensors, according to some example embodiments.

Referring to FIG. 11, the X-axis represents wavelengths. The Y-axis represents reflectance (e.g., surface reflection (%)) of respective image sensors. The wavelength band represented by the X-axis is within the range of 400 nm to 700 nm, which is similar to the wavelength band of visible light. 520 nm in the wavelength band, which is a green band, will be mainly described. A denotes a case in which an upper anti-reflection layer is formed as a single film using a related-art oxide film. B denotes a case in which three upper anti-reflection layers are formed. C denotes a case in which four upper anti-reflection layers are formed. Referring to the graph, it may be seen that the reflectance of A for about 520 nm is highest, at about 8% to 9%. It may be seen that the reflectance of B and C for about 520 nm are about 5% to 6%, which is relatively lower than that of A. It may be seen that the peak value of the reflectance of A is about 9.5%, the peak value of the reflectance of B is about 7.0%, the peak value of the reflectance of C is about 6.6%, and the order of the peak values from highest to lowest is A, B, and C. That is, it may be seen that the reflectance is effectively reduced by forming a plurality of films with reflectance that increase toward the bottom and by increasing the number of films, as proposed in the inventive concepts, compared to when forming a single film.

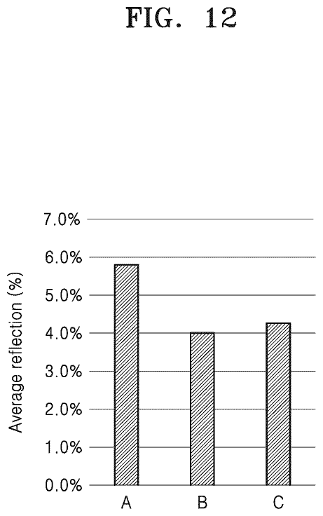

FIG. 12 is a graph showing average reflectance of image sensors according to some example embodiments.

Referring to FIG. 12, the Y-axis represents average reflectance (e.g., average reflection (%)) of respective image sensors. A, B, and C are the same as those described above with reference to FIG. 11. Referring to the average reflectance of each case, the average reflectance of A is about 5.8%. The average reflectance of B is about 4%. The average reflectance of C is about 4.2%. That is, it may be seen that, in a case of forming a plurality of films with reflectance that increase toward the bottom as proposed in the inventive concepts, rather than forming a related-art single oxide film, the average reflectance in the wavelength band of visible light is effectively reduced.

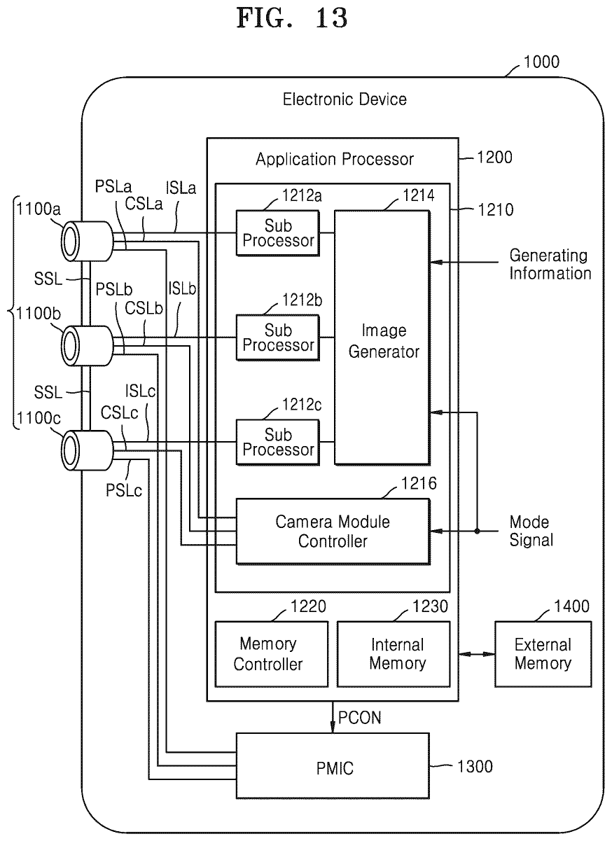

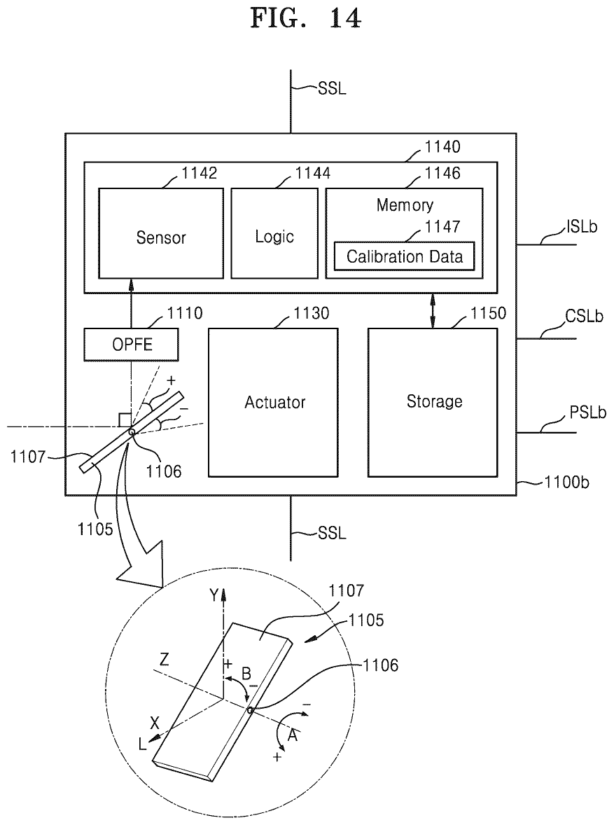

FIG. 13 is a block diagram of an electronic device including multiple camera modules. FIG. 14 is a detailed block diagram of the camera module of FIG. 13.

Referring to FIG. 13, an electronic device 1000 may include a camera module group 1100, an application processor 1200, a power management integrated circuit (PMIC) 1300, and a storage 1400.

The camera module group 1100 may include a plurality of camera modules 1100a, 1100b, and 1100c. FIG. 13 illustrate some example embodiments in which three camera modules 1100a, 1100b, and 1100c are arranged, but example embodiments are not limited thereto. In some example embodiments, the camera module group 1100 may be modified to include only two camera modules or to include n camera modules (n is a natural number of 4 or greater).

Referring to FIG. 14, the camera module 1100b may include a prism 1105, an optical path folding element (OPFE) 1110, an actuator 1130, an image sensing device 1140, and a storage 1150.

Here, a detailed configuration of one camera module 1100b will be described in more detail, but the following description may be equally applied to the other camera modules 1100a and 1100c according to some example embodiments.

The prism 1105 may include a reflective surface 1107 of a light-reflective material, and thus may change the path of light incident from outside.

In some example embodiments, the prism 1105 may change the path of the light incident in the first direction (the X direction) to be in the second direction (the Y direction) that is perpendicular to the first direction (the X direction). In addition, the prism 1105 may change the path of the light incident in the first direction (the X direction) to be in the second direction (the Y direction) that is perpendicular to the first direction, by rotating the reflective surface 1107 of the light-reflective material in the A direction around a central axis 1106 or by rotating the central axis 1106 in the B direction. In this case, the OPFE 1110 may also move in the first direction (the X direction), the second direction (the Y direction), and the third direction (the Z direction).

In some example embodiments, as illustrated in FIG. 14, the maximum rotation angle of the prism 1105 in the direction A may be less than or equal to 15° in the positive (+) A direction and greater than 15° in the negative (−) A direction, but example embodiments are not limited thereto.

In some example embodiments, the prism 1105 may move within 20°, between 10° and 20°, or between 15° and 20° in the positive (+) or negative (−) B direction, wherein the prism 1105 may move at the same angle in the positive (+) or negative (−) B direction, or to a nearly similar angle within the range of 1°.

In some example embodiments, the prism 1105 may move the reflective surface 1107 of the light-reflective material in the third direction (the Z direction) that is parallel to an extension direction of the central axis 1106.

The OPFE 1110 may include, for example, m optical lenses (m is a natural number). The m lenses may move in the second direction (the Y direction) to change an optical zoom ratio of the camera module 1100b. For example, in a case in which the basic optical zoom ratio of the camera module 1100b is z, when the m optical lenses included in the OPFE 1110 is moved, the optical zoom ratio of the camera module 1100b may be changed to 3z, 5z, 7z, or greater.

The actuator 1130 may move the OPFE 1110 or the optical lens to a particular position. For example, the actuator 1130 may adjust the position of the optical lens such that an image sensor 1142 is located at a focal length of the optical lens for accurate sensing.

The image sensing device 1140 may include the image sensor 1142, a control logic 1144, and a memory 1146. The image sensor 1142 may sense an image of a sensing target by using the light provided through the optical lens. The control logic 1144 may control the overall operation of the camera module 1100b. For example, the control logic 1144 may control an operation of the camera module 1100b according to a control signal provided through a control signal line CSLb.

The memory 1146 may store information necessary for an operation of the camera module 1100b, for example, calibration data 1147. The calibration data 1147 may include information necessary for the camera module 1100b to generate image data by using light provided from the outside. The calibration data 1147 may include, for example, information about a degree of rotation described above, information about a focal length, information about an optical axis, and the like. In a case in which the camera module 1100b is implemented in the form of a multi-state camera in which the focal length varies according to the position of the optical lens, the calibration data 1147 may include a focal length value of the optical lens for each position (or state) and information related to auto-focusing.

The storage 1150 may store image data sensed by the image sensor 1142. The storage 1150 may be arranged outside the image sensing device 1140, and may be implemented to be stacked with a sensor chip constituting the image sensing device 1140. In some example embodiments, the storage 1150 may be implemented as electrically erasable programmable read-only memory (EEPROM), but example embodiments are not limited thereto.

Referring to FIGS. 13 and 14 together, in some example embodiments, each of the plurality of camera modules 1100a, 1100b, and 1100c may include the actuator 1130. Accordingly, each of the plurality of camera modules 1100a, 1100b, and 1100c may include the same or different calibration data 1147 according to an operation of the actuator 1130 included therein.

In some example embodiments, any one (e.g., 1100b) of the plurality of camera modules 1100a, 1100b, and 1100c may be a folded-lens-type camera module including the prism 1105 and the OPFE 1110 described above, and the other camera modules (e.g., 1100a and 1100c) may be vertical-type camera modules that do not include the prism 1105 and the OPFE 1110, but the inventive concepts are not limited thereto.

In some example embodiments, any one (e.g., 1100c) of the plurality of camera modules 1100a, 1100b, and 1100c may be, for example, a vertical-type depth camera that extracts depth information by using infrared (IR) rays. In this case, the application processor 1200 may merge image data provided from the depth camera and image data provided from another camera module (e.g., 1100a or 1100b) to generate a three-dimensional (3D) depth image.

In some example embodiments, at least two (e.g., 1100a and 1100b) of the plurality of camera modules 1100a, 1100b, and 1100c may have different fields of view. In this case, optical lenses of the at least two camera modules (e.g., 1100a and 1100b) among the plurality of camera modules 1100a, 1100b, and 1100c may be different from each other, but the inventive concepts are not limited thereto.

In addition, in some example embodiments, the fields of view of the plurality of camera modules 1100a, 1100b, and 1100c may be different from each other. In this case, the optical lenses included in the plurality of camera modules 1100a, 1100b, and 1100c may also be different from each other, but the inventive concepts are not limited thereto.

In some example embodiments, the plurality of camera modules 1100a, 1100b, and 1100c may be arranged to be physically separated from each other. That is, the plurality of camera modules 1100a, 1100b, and 1100c do not divide a sensing region of one image sensor 1142 for use, but an independent image sensor 1142 may be arranged inside each of the plurality of camera modules 1100a, 1100b, and 1100c.

Referring back to FIG. 13, the application processor 1200 may include an image processing device 1210, a memory controller 1220, and an internal memory 1230. The application processor 1200 may be implemented separately from the plurality of camera modules 1100a, 1100b, and 1100c. For example, the application processor 1200 and the plurality of camera modules 1100a, 1100b, and 1100c may be implemented as separate semiconductor chips from each other.

The image processing device 1210 may include a plurality of sub-image processors 1212a, 1212b, and 1212c, an image generator 1214, and a camera module controller 1216.

The image processing device 1210 may include the plurality of sub-image processors 1212a, 1212b, and 1212c, the number of which corresponds to the number of the plurality of camera modules 1100a, 1100b, and 1100c.

Image data generated by the camera modules 1100a, 1100b, and 1100c may be provided to the corresponding sub-image processors 1212a, 1212b, and 1212c through image signal lines ISLa, ISLb, and ISLc separated from each other, respectively. For example, the image data generated by the camera module 1100a may be provided to the sub-image processor 1212a through the image signal line ISLa, the image data generated by the camera module 1100b may be provided to the sub-image processor 1212b through the image signal line ISLb, and the image data generated by the camera module 1100c may be provided to the sub-image processor 1212c through the image signal line ISLc. Such transfer of image data may be performed by using, for example, Camera Serial Interface (CSI) based on Mobile Industry Processor Interface (MIPI), but is not limited thereto.

Meanwhile, in some example embodiments, one sub-image processor may be arranged to correspond to a plurality of camera modules. For example, the sub-image processor 1212a and the sub-image processor 1212c may not be separated from each other as illustrated in FIG. 13, but may be integrated into one sub-image processor, such that the image data provided by the camera module 1100a and the camera module 1100c may be selected through a selection element (e.g., a multiplexer) and then provided to the integrated sub-image processor.

The image data provided to each of the sub-image processors 1212a, 1212b, and 1212c may be provided to the image generator 1214. The image generator 1214 may generate an output image by using the image data provided by each of the sub-image processors 1212a, 1212b, and 1212c according to image generating information or a mode signal.

In detail, the image generator 1214 may generate output image by merging at least some of the image data generated by the camera modules 1100a, 1100b, and 1100c having different fields of view according to the image generating information or mode signal. In addition, the image generator 1214 may generate output image by selecting any one of pieces of image data generated by the camera modules 1100a, 1100b, and 1100c having different fields of view according to the image generating information or mode signal.

In some example embodiments, the image generating information may include a zoom signal (or a zoom factor). In addition, in some example embodiments, the mode signal may be, for example, a signal based on a mode selected by a user.

In a case in which the image generating information is a zoom signal (a zoom factor), and the camera modules 1100a, 1100b, and 1100c have different fields of view, the image generator 1214 may perform different operations according to the type of the zoom signal. For example, in a case in which the zoom signal is a first signal, the image generator 1214 may merge image data output from the camera module 1100a and image data output from the camera module 1100c, and then generate output image by using an image signal obtained through the merging, and the image data output from the camera module 1100b that has not been used for the merging. In a case in which the zoom signal is a second signal that is different from the first signal, the image generator 1214 does not perform such image data merging, and may select any one of pieces of image data output from the camera modules 1100a, 1100b, and 1100c to generate output image. However, the inventive concepts are not limited thereto, and the method of processing image data may be modified and implemented as needed.

In some example embodiments, the image generator 1214 may receive a plurality of pieces of image data with different exposure times from at least one of the plurality of sub-image processors 1212a, 1212b, and 1212c, and generate merged image data having an increased dynamic range by performing high dynamic range (HDR) processing on the plurality of pieces of image data.

The camera module controller 1216 may provide a control signal to each of the camera modules 1100a, 1100b, and 1100c. The control signals generated by the camera module controller 1216 may be provided to the corresponding camera modules 1100a, 1100b, and 1100c through control signal lines CSLa, CSLb, and CSLc separated from each other, respectively.

Any one of the plurality of camera modules 1100a, 1100b, and 1100c may be designated as a master camera module (e.g., 1100b) according to the image generating information or mode signal including the zoom signal, and the other camera modules (e.g., 1100a and 1100c) may be designated as slave cameras. Such information may be included in the control signals and then provided to the corresponding camera modules 1100a, 1100b, and 1100c through the control signal lines CSLa, CSLb, and CSLc separated from each other, respectively.

A camera module operating as a master and a slave may be changed according to a zoom factor or an operation mode signal. For example, in a case in which the field of view of the camera module 1100a is wider than the field of view of the camera module 1100b, and the zoom factor indicates a low zoom ratio, the camera module 1100b may operate as a master, and the camera module 1100a may operate as a slave. On the contrary, in a case in which the zoom factor indicates a high zoom ratio, the camera module 1100a may operate as a master and the camera module 1100b may operate as a slave.

In some example embodiments, the control signal provided from the camera module controller 1216 to each of the camera modules 1100a, 1100b, and 1100c may include a sync enable signal. For example, in a case in which the camera module 1100b is a master camera and the camera modules 1100a and 1100c are slave cameras, the camera module controller 1216 may transmit a sync enable signal to the camera module 1100b. The camera module 1100b that has received the sync enable signal may generate a sync signal based on the received sync enable signal, and provide the generated sync signal to the camera modules 1100a and 1100c through a sync signal line SSL. The camera module 1100b and the camera modules 1100a and 1100c may be synchronized with each other based on the sync signal to transmit image data to the application processor 1200.

In some example embodiments, the control signals provided from the camera module controller 1216 to the plurality of camera modules 1100a, 1100b, and 1100c may include mode information according to mode signals. Based on the mode information, the plurality of camera modules 1100a, 1100b, and 1100c may operate in a first operation mode and a second operation mode in relation to a sensing rate.

In the first operation mode, the plurality of camera modules 1100a, 1100b, and 1100c may generate an image signal at a first rate (e.g., generate an image signal at a first frame rate), encode the image signal at a second rate that is higher than the first rate (e.g., encode the image signal at a second frame rate that is higher than the first frame rate), and transmit the encoded image signal to the application processor 1200.

The application processor 1200 may store the received image signal, that is, the encoded image signal, in the memory 1230 provided therein or in the storage 1400 outside the application processor 1200, and then, read and decode the encoded image signal from the memory 1230 or the storage 1400, and display image data generated based on the decoded image signal. For example, the corresponding sub-processor among the plurality of sub-image processors 1212a, 1212b, and 1212c of the image processing device 1210 may perform decoding, and may also perform image processing on the decoded image signal.

In the second operation mode, the plurality of camera modules 1100a, 1100b, and 1100c may generate an image signal at a third rate that is lower than the first rate (e.g., generate an image signal at a third frame rate that is lower than the first frame rate), and transmit the image signal to the application processor 1200. The image signal provided to the application processor 1200 may be an unencoded signal. The application processor 1200 may perform image processing on the received image signal or store the image signal in the memory 1230 or the storage 1400.

The PMIC 1300 may supply power, for example, a power voltage, to each of the plurality of camera modules 1100a, 1100b, and 1100c. For example, the PMIC 1300 may supply first power to the camera module 1100a through a power signal line PSLa, supply second power to the camera module 1100b through a power signal line PSLb, and supply third power to the camera module 1100c through a power signal line PSLc, under control of the application processor 1200.

In response to a power control signal PCON from the application processor 1200, the PMIC 1300 may generate power corresponding to each of the plurality of camera modules 1100a, 1100b, and 1100c, and adjust the level of the power. The power control signal PCON may include a power adjustment signal for each operation mode of the plurality of camera modules 1100a, 1100b, and 1100c. For example, the operation mode may include a low-power mode, and in this case, the power control signal PCON may include information about a camera module operating in the low-power mode and a set power level. The levels of power provided to the plurality of camera modules 1100a, 1100b, and 1100c may be the same or different from each other. In addition, the levels of power may be changed dynamically.

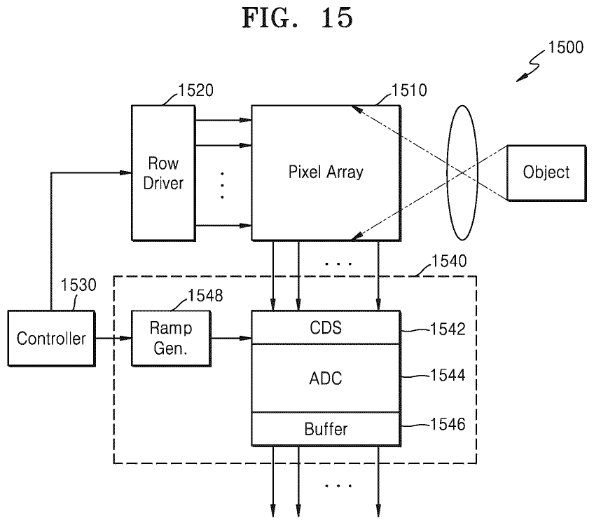

FIG. 15 is a block diagram illustrating a configuration of an image sensor according to some example embodiments.

Referring to FIG. 15, an image sensor 1500 may include a pixel array 1510, a controller 1530, a row driver 1520, and a pixel signal processor 1540.

The image sensor 1500 may include at least one of the image sensors 100a, 100a, or 100c described above. The pixel array 1510 may include a plurality of two-dimensionally arranged unit pixels, and each unit pixel may include a photoelectric conversion device. The photoelectric conversion device may absorb light to generate photocharges, and an electrical signal (an output voltage) according to the generated photocharges may be provided to the pixel signal processor 1540 through a vertical signal line.

The unit pixels included in the pixel array 1510 may provide an output voltage one at a time in row units, and accordingly, the unit pixels in one row of the pixel array 1510 may be simultaneously activated by a selection signal output by the row driver 1520. The unit pixels in a selected row may provide an output voltage according to the absorbed light, to an output line of a corresponding column.

The controller 1530 may control the row driver 1520 to cause the pixel array 1510 to absorb light and accumulate photocharges, temporarily store the accumulated photocharges, and output an electrical signal according to the stored photocharges to the outside of the pixel array 1510. In addition, the controller 1530 may control the pixel signal processor 1540 to measure the output voltage provided by the pixel array 1510.

The pixel signal processor 1540 may include a correlated double sampler 1542, an analog-to-digital converter 1544, and a buffer 1546. The correlated double sampler 1542 may sample and hold the output voltage provided by the pixel array 1510.

The correlated double sampler 1542 may double-sample a particular noise level and a level according to a generated output voltage, and output a level corresponding to a difference therebetween. In addition, the correlated double sampler 1542 may receive ramp signals generated by a ramp signal generator 1548, compare the ramp signals with each other, and output a result of the comparison.

The analog-to-digital converter 1544 may convert an analog signal corresponding to the level received from the correlated double sampler 1542 into a digital signal. The buffer 1546 may latch the digital signal, and the latched signal may be sequentially output to the outside of the image sensor 1500 and transferred to an image processor (not shown).

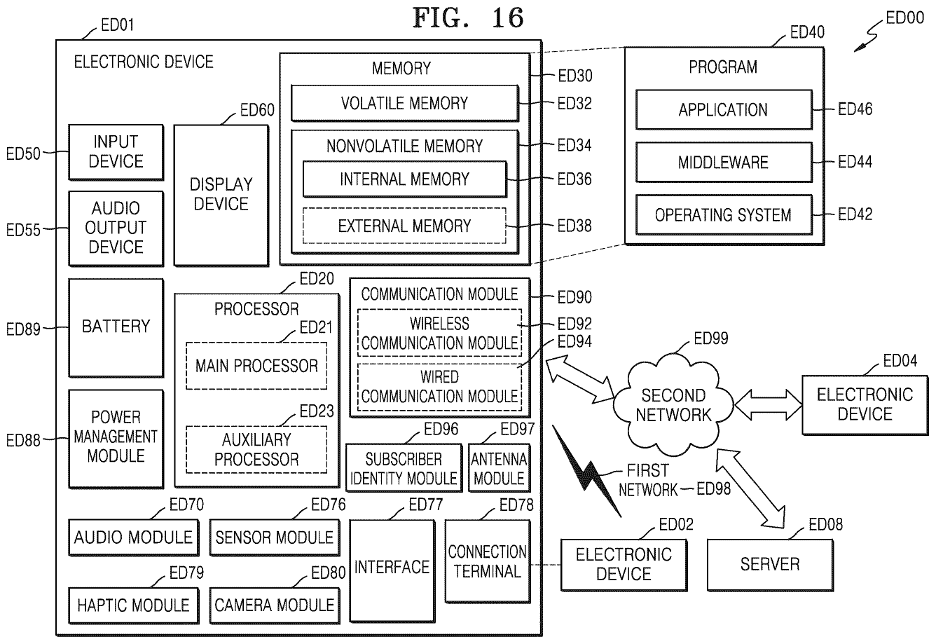

FIG. 16 is a block diagram schematically illustrating an electronic device including an image sensor, according to some example embodiments.

Referring to FIG. 16, in a network environment ED00, an electronic device ED01 may communicate with an electronic device ED02 through a first network ED98 (e.g., a short-range wireless communication network), or may communicate an electronic device ED04 and/or a server ED08 through a second network ED99 (e.g., a long-range wireless communication network). The electronic device ED01 may communicate with the electronic device ED04 via the server ED08. The electronic device ED01 may include a processor ED20, a memory ED30, an input device ED50, an audio output device ED55, a display device ED60, an audio module ED70, a sensor module ED76, an interface ED77, a haptic module ED79, a camera module ED80, a power management module ED88, a battery ED89, a communication module ED90, a subscriber identification module ED96, and/or an antenna module ED97. In the electronic device ED01, some of these components (e.g., the display device ED60) may be omitted, or other components may be added. Some of these components may be implemented as a single integrated circuit. For example, the sensor module ED76 (e.g., a fingerprint sensor, an iris sensor, or an illuminance sensor) may be embedded in the display device ED60 (e.g., a display) to be implemented.

The processor ED20 may execute software (e.g., a program ED40) to control one or more other components (e.g., hardware and software components) of the electronic device ED01 connected to the processor ED20, and to perform various data processes or computations. As part of the data processes or computations, the processor ED20 may load commands and/or data received from other components (e.g., the sensor module ED76 or the communication module ED90) into a volatile memory ED32, process the commands and/or data stored in the volatile memory ED32, and store result data in a nonvolatile memory ED34. The processor ED20 may include a main processor ED21 (e.g., a central processing unit or an application processor) and an auxiliary processor ED23 (e.g., a graphics processing unit, an image signal processor, a sensor hub processor, or a communication processor) that may operate independently or together with the main processor ED21. The auxiliary processor ED23 may consume less power than the main processor ED21 and may perform a specialized function.

The auxiliary processor ED23 may control functions and/or states related to some of the components (e.g., the display device ED60, the sensor module ED76, or the communication module ED90) of the electronic device ED01, on behalf of the main processor ED21 while the main processor ED21 is in an inactive state (e.g., a sleep state) or together with the main processor ED21 while the main processor ED21 is in an active state (e.g., an application execution state). The auxiliary processor ED23 (e.g., an image signal processor or a communication processor) may also be implemented as part of other functionally relevant components (e.g., the camera module ED80 or the communication module ED90).

The memory ED30 may store various pieces of data required by components (e.g., the processor ED20 or the sensor module ED76) of the electronic device ED01. The data may include, for example, software (such as the program ED40), and input data and/or output data for commands related to the software. The memory ED30 may include the volatile memory ED32 and/or the nonvolatile memory ED34. The nonvolatile memory ED32 may include an internal memory ED36 fixedly mounted in the electronic device ED01 and a removable external memory ED38.

The program ED40 may be stored as software in the memory ED30 and may include an operating system ED42, middleware ED44, and/or an application ED46.

The input device ED50 may receive commands and/or data to be used for components (e.g., the processor ED20) of the electronic device ED01 from an external source (e.g., a user) of the electronic device ED01. The input device ED50 may include a microphone, a mouse, a keyboard, and/or a digital pen (e.g., a stylus pen).

The audio output device ED55 may output an audio signal to the outside of the electronic device ED01. The audio output device ED55 may include a speaker and/or a receiver. The speaker may be used for general purposes such as reproducing multimedia or recordings, and the receiver may be used to receive incoming calls. The receiver may be integrated as part of the speaker or may be implemented as a separate, independent device.

The display device ED60 may visually provide information to the outside of the electronic device ED01. The display device ED60 may include a display, a holographic device, or a projector, and a control circuit for controlling the device. The display device ED60 may include touch circuitry configured to detect a touch, and/or sensor circuitry (e.g., a pressure sensor) configured to measure the intensity of a force generated by a touch.

The audio module ED70 may convert sound into electrical signals, or vice versa. The audio module ED70 may obtain sound through the input device ED50, or output sound through a speaker and/or a headphones of the audio output device ED55, and/or another electronic device (e.g., the electronic device ED02) directly or wirelessly connected to the electronic device ED01.

The sensor module ED76 may detect an operating state (e.g., power or temperature) of the electronic device ED01 or an external environmental state (e.g., a user state) and generate an electrical signal and/or a data value corresponding to the detected state. The sensor module ED76 may include a gesture sensor, a gyro sensor, a barometric sensor, a magnetic sensor, an acceleration sensor, a grip sensor, a proximity sensor, a color sensor, an IR sensor, a biometric sensor, a temperature sensor, a humidity sensor, and/or an illuminance sensor.

The interface ED77 may support one or more designated protocols that may be used to directly or wirelessly connect the electronic device ED01 to another electronic device (e.g., the electronic device ED02). The interface ED77 may include a High-Definition Multimedia Interface (HDMI) port, a Universal Serial Bus (USB) interface, a Secure Digital (SD) card interface, and/or an audio interface.

A connection terminal ED78 may include a connector through which the electronic device ED01 may be physically connected to another electronic device (e.g., the electronic device ED02). The connection terminal ED78 may include an HDMI connector, a USB connector, an SD card connector, and/or an audio connector (e.g., a headphone connector).

The haptic module ED79 may convert electrical signals into mechanical stimuli (e.g., vibration or movement) or electrical stimuli that the user may perceive through tactile or kinesthetic sensations. The haptic module ED79 may include a motor, a piezoelectric element, and/or an electrical stimulation device.

The camera module ED80 may capture a still image and a moving image. The camera module ED80 may include a lens assembly including one or more lenses, the image sensor 100 of FIG. 1, image signal processors, and/or flashes. The lens assembly included in the camera module ED80 may collect light emitted from a subject to be image-captured.

The power management module ED88 may manage power supplied to the electronic device ED01. The power management module ED88 may be implemented as part of a PMIC.

The battery ED89 may power the components of the electronic device ED01. The battery ED89 may include a non-rechargeable primary battery, a rechargeable secondary battery, and/or a fuel cell.

The communication module ED90 may support establishment of a direct (wired) communication channel and/or a wireless communication channel between the electronic device ED01 and another electronic device (e.g., the electronic device ED02, the electronic device ED04, or the server ED08), and communication through the established communication channel. The communication module ED90 may include one or more communication processors that operate independently of the processor ED20 (e.g., an application processor) and support direct communication and/or wireless communication. The communication module ED90 may include a wireless communication module ED92 (e.g., a cellular communication module, a short-range wireless communication module, or a global navigation satellite system (GNSS) communication module) and/or a wired communication module ED94 (e.g., a local area network (LAN) communication module or a power line communication module). The corresponding communication module may communicate with other electronic devices via the first network ED98 (e.g., a short-range communication network such as Bluetooth, Wi-Fi Direct, or Infrared Data Association (IrDA)) or the second network ED99 (e.g., a long-range communication network such as a cellular network, the Internet, or a computer network (e.g., a LAN or a wide area network (WAN)). These various types of communication modules may be integrated into a single component (e.g., a single chip) or may be implemented as a plurality of separate components (e.g., a plurality of chips). The wireless communication module ED92 may identify and authenticate the electronic device ED01 within a communication network such as the first network ED98 and/or the second network ED99, by using subscriber information (e.g., an international mobile subscriber identity (IMSI)) stored in the subscriber identification module ED96.

The antenna module ED97 may transmit or receive signals and/or power to or from the outside (e.g., another electronic device). The antenna may include a radiator made of a conductive pattern on a substrate (e.g., a printed circuit board (PCB)). The antenna module ED97 may include one or more antennas. In a case in which the antenna module ED97 includes a plurality of antennas, the communication module ED90 may select an antenna suitable for a communication scheme used in a communication network such as the first network ED98 and/or the second network ED99, from among the plurality of antennas. Signals and/or power may be transmitted or received between the communication module ED90 and other electronic devices via the selected antenna. In addition to the antennas, other components (e.g., a radio-frequency integrated circuit (RFIC)) may be included as part of the antenna module ED97.

Some of the components may be connected to each other and exchange signals (e.g., commands or data) through a communication scheme between peripheral devices (e.g., a bus, a general-purpose input/output (GPIO), Serial Peripheral Interface (SPI), or MIPI).

The commands or data may be transmitted or received between the electronic device ED01 and the external electronic device ED04 via the server ED08 connected to the second network ED99. The types of the electronic devices ED02 and ED04 may be the same as or different from the type of the electronic device ED01. All or some of the operations performed by the electronic device ED01 may be performed by one or more of the electronic devices ED02, ED04, and ED08. For example, when the electronic device ED01 is required to perform a certain function or service, the electronic device ED01 may request one or more other electronic devices to perform part or all of the function or service, instead of performing the function or service on its own. The one or more other electronic devices that has received the request may execute an additional function or service related to the request, and transmit a result of the execution to the electronic device ED01. To this end, cloud computing, distributed computing, and/or client-server computing technologies may be used.

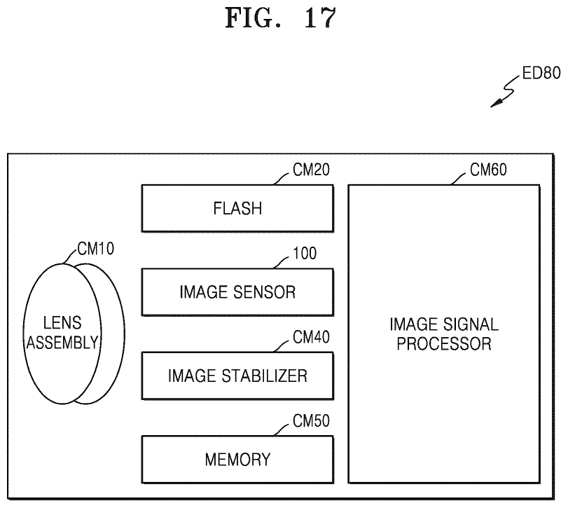

FIG. 17 is a block diagram schematically illustrating the camera module of FIG. 16.

Referring to FIG. 17, the camera module ED80 may include a lens assembly CM10, a flash CM20, the image sensor 100 (e.g., the image sensor 100 of FIG. 1), an image stabilizer CM40, a memory CM50 (e.g., a buffer memory), and/or an image signal processor CM60. The lens assembly CM10 may collect light emitted from a subject to be image-captured. The camera module ED80 may include a plurality of lens assemblies CM10, and in this case, the camera module ED80 may be a dual camera, a 360-degree camera, or a spherical camera. Some of the plurality of lens assemblies CM10 may have the same lens properties (e.g., an angle of view, a focal length, autofocus, an F-number, or optical zoom) or may have different lens properties. The lens assembly CM10 may include a wide-angle lens or a telephoto lens.

The flash CM20 may emit light to be used to enhance light emitted or reflected from a subject. The flash CM20 may include one or more light-emitting diodes (e.g., red-green-blue (RGB) light-emitting diodes (LEDs), white LEDs, IR LEDs, or ultraviolet LEDs), and/or a xenon lamp. The image sensor 100 may be the image sensor described above with reference to FIG. 1, and may obtain an image corresponding to a subject by converting, into an electrical signal, light that has been emitted or reflected from the subject and then transmitted through the lens assembly CM10. The image sensor 100 may include one or more sensors selected from image sensors with different properties, such as an RGB sensor, a black-and-white (BW) sensor, an IR sensor, or an ultraviolet (UV) sensor. Each sensor included in the image sensor 100 may be implemented as a charge-coupled device (CCD) sensor and/or a complementary metal-oxide-semiconductor (CMOS) sensor.

In response to a movement of the camera module ED80 or the electronic device ED01 including the camera module ED80, the image stabilizer CM40 may move the one or more lenses included in the lens assembly CM10 or the image sensor 100 in a particular direction, or control the operating characteristics of the image sensor 100 (e.g., adjust a readout timing), such that a negative effect due to the movement is compensated for. The image stabilizer CM40 may detect a movement of the camera module ED80 or the electronic device ED01 by using a gyro sensor (not shown) or an acceleration sensor (not shown) arranged inside or outside the camera module ED80. The image stabilizer CM40 may also be implemented in an optical manner.

The memory CM50 may store part or all of image data obtained through the image sensor 100 for the next image processing task. For example, when a plurality of images are obtained at high speed, the obtained original data (e.g., Bayer-patterned data or high-resolution data) may be stored in the memory CM50, only low-resolution images may be displayed, and then the original data of selected (e.g., user-selected) images may be transmitted to the image signal processor CM60. The memory CM50 may be integrated into the memory ED30 of the electronic device ED01 or may be configured as a separate memory that operates independently.

The image signal processor CM60 may perform image processes on an image obtained through the image sensor 100 or image data stored in the memory CM50. The image processes may include depth map generation, three-dimensional modeling, panorama generation, feature point extraction, image synthesis, and/or image compensation (e.g., noise reduction, resolution adjustment, brightness adjustment, blurring, sharpening, or softening). The image signal processor CM60 may perform control (exposure time control or readout timing control) of components (e.g., the image sensor 100) included in the camera module ED80. An image processed by the image signal processor CM60 may be stored back in the memory CM50 for further processing or may be provided to external components of the camera module ED80 (e.g., the memory ED30, the display device ED60, the electronic device ED02, the electronic device ED04, or the server ED08). The image signal processor CM60 may be integrated into the processor ED20 or may be configured as a separate processor that operates independently of the processor ED20. In a case in which the image signal processor CM60 is configured as a separate processor from the processor ED20, an image processed by the image signal processor CM60 may be displayed through the display device ED60 after undergoing additional image processing by the processor ED20.

The electronic device ED01 may include a plurality of camera modules ED80 having different properties or functions. In this case, one of the plurality of camera modules ED80 may be a wide-angle camera and another may be a telephoto camera. Similarly, one of the plurality of camera modules ED80 may be a front camera and another may be a rear camera.

As described herein, any devices, systems, modules, portions, units, controllers, circuits, and/or portions thereof according to any of the example embodiments, and/or any portions thereof (including, without limitation, the image sensor 100, the pixel array 10, the column driver 20, the row driver 30, the timing controller 40, the readout circuit 50, the image processor 70, the image sensor 100a, the image sensor 100b, the image sensor 100c, the electronic device 1000, the plurality of camera modules 1100a, 1100b, and 1100c, the prism 1105, the optical path folding element OPFE 1110, the actuator 1130, the image sensing device 1140, the image sensor 1142, the control logic 1144, the memory 1146, the storage 1150, the application processor 1200, the image processing device 1210, the plurality of sub-image processors 1212a, 1212b, and 1212c, the image generator 1214, the camera module controller 1216, the memory controller 1220, the internal memory 1230, the PMIC 1300, the storage 1400, the image sensor 1500, the pixel array 1510, the row driver 1520, the controller 1530, the pixel signal processor 1540, the ramp signal generator 1548, the correlated double sampler 1542, the ADC 1544, the buffer 1546, the network environment ED00, the electronic device ED01, the ED02, the electronic device ED04, the server ED08, the processor ED20, the memory ED30, the input device ED50, the audio output device ED55, the display device ED60, the audio module ED70, the sensor module ED76, the interface ED77, the haptic module ED79, the camera module ED80, the power management module ED88, the battery ED89, the communication module ED90, the subscriber identification module ED96, the antenna module ED97, the program ED40, the lens assembly CM10, the flash CM20, the image stabilizer CM40, the memory CM50, the image signal processor CM60, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

The above-described embodiments are examples, and various modifications and equivalent example embodiments are possible from those skilled in the art to which the inventive concepts pertain. Therefore, the true technical protection scope according to the example embodiments should be determined by the technical spirit described in the following claims.

While the inventive concepts have been particularly shown and described with reference to some example embodiments thereof, it will be understood that various changes in form and details may be made therein without departing from the spirit and scope of the following claims.

1. An image sensor, comprising:
a sensor substrate including a plurality of first pixels and a plurality of second pixels, wherein the plurality of first pixels are configured to sense light of a first wavelength, and the plurality of second pixels are configured to sense light of a second wavelength different from the first wavelength;
first color filters and second color filters, the first color filters and the second color filters above the sensor substrate, the first color filters and the second color filters corresponding to the plurality of first pixels and the plurality of second pixels, respectively;
a transparent spacer on both the first color filters and the second color filters;
at least one meta-micro-lens array including a plurality of nano-posts above the transparent spacer, the plurality of nano-posts to condense incident light onto the plurality of first pixels and the plurality of second pixels; and
a plurality of upper anti-reflection layers on a light-incident surface of the at least one meta-micro-lens array,
wherein the plurality of upper anti-reflection layers are stacked to overlap each other in a vertical direction, the vertical direction perpendicular to an upper surface of the sensor substrate, and
wherein refractive indices of the plurality of upper anti-reflection layers increase toward the at least one meta-micro-lens array in the vertical direction.

2. The image sensor of claim 1, wherein the refractive indices of the plurality of upper anti-reflection layers are smaller than a refractive index of the at least one meta-micro-lens array and greater than a refractive index of air.

3. The image sensor of claim 1, wherein a refractive index of each upper anti-reflection layer of the plurality of upper anti-reflection layers linearly increases by about 0.2 for every 100 nm of a thickness of the each upper anti-reflection layer in the vertical direction.

4. The image sensor of claim 1, wherein
at least one upper anti-reflection layer of the plurality of upper anti-reflection layers includes a plurality of holes that are arranged periodically in two dimensions, and
the plurality of holes are exposed to an exterior of the image sensor.

5. The image sensor of claim 4, wherein a cross-sectional area of each hole of the plurality of holes in a horizontal direction has a tapered shape that narrows toward the at least one meta-micro-lens array.

6. The image sensor of claim 1, wherein
the plurality of upper anti-reflection layers includes a first upper anti-reflection layer, a second upper anti-reflection layer, and a third upper anti-reflection layer,
the third upper anti-reflection layer is at a lowest position, among the plurality of upper anti-reflection layers, the third upper anti-reflection layer including a plurality of holes that are arranged periodically in two dimensions,
the second upper anti-reflection layer is on the third upper anti-reflection layer, among the plurality of upper anti-reflection layers, the second upper anti-reflection layer covering an outer surface of the third upper anti-reflection layer, and
the first upper anti-reflection layer is on the second upper anti-reflection layer, among the plurality of upper anti-reflection layers, the first upper anti-reflection layer covering an outer surface of the second upper anti-reflection layer.

7. The image sensor of claim 6, wherein a cross-sectional area of the third upper anti-reflection layer in a horizontal direction has a shape that widens toward the at least one meta-micro-lens array.

8. The image sensor of claim 6, wherein an uppermost surface of at least one of the second upper anti-reflection layer or the first upper anti-reflection layer is planar.

9. The image sensor of claim 1, wherein a thickness of each of the plurality of upper anti-reflection layers in the vertical direction is about 100 angstroms (Å) to about 2,000 angstroms (Å).

10. The image sensor of claim 1, further comprising an etch stopper between the transparent spacer and the at least one meta-micro-lens array.

11. An image sensor, comprising:
a sensor substrate including a plurality of first pixels and a plurality of second pixels, wherein the plurality of first pixels are configured to sense light of a first wavelength, and the plurality of second pixels are configured to sense light of a second wavelength that is different from the first wavelength;
a transparent spacer above the sensor substrate;
first color filters and second color filters, the first color filters and the second color filters between the sensor substrate and the transparent spacer, the first color filters and the second color filters corresponding to the plurality of first pixels and the plurality of second pixels, respectively;
color filter fences between the first color filters and the second color filters;
a first meta-micro-lens array including a plurality of first nano-posts, the plurality of first nano-posts above the transparent spacer, the plurality of first nano-posts configured to condense incident light onto the plurality of first pixels and the plurality of second pixels;
a second meta-micro-lens array above the first meta-micro-lens array, the second meta-micro-lens array including a plurality of second nano-posts at positions in a horizontal direction that are different from positions of the plurality of first nano-posts in the horizontal direction, such that the plurality of second nano-posts are offset from the plurality of first nano-posts in the horizontal direction, the horizontal direction extending parallel to an upper surface of the sensor substrate;
a first etch stopper between the transparent spacer and the first meta-micro-lens array; and
a plurality of upper anti-reflection layers on a light-incident surface of the second meta-micro-lens array,
wherein the plurality of upper anti-reflection layers are stacked to overlap each other in a vertical direction extending perpendicular to the upper surface of the sensor substrate,
wherein refractive indices of the plurality of upper anti-reflection layers increase toward the second meta-micro-lens array in the vertical direction, and
wherein the refractive indices of the plurality of upper anti-reflection layers are smaller than a refractive index of the first meta-micro-lens array and greater than a refractive index of air.

12. The image sensor of claim 11, wherein
at least one upper anti-reflection layer of the plurality of upper anti-reflection layers comprises a plurality of holes that are arranged periodically in two dimensions,
the plurality of holes are exposed to an exterior of the image sensor, and
a cross-sectional area of each of the plurality of holes in the horizontal direction has a tapered shape that narrows toward the second meta-micro-lens array.

13. The image sensor of claim 11, wherein
the plurality of upper anti-reflection layers includes a first upper anti-reflection layer, a second upper anti-reflection layer, and a third upper anti-reflection layer,
the third upper anti-reflection layer is at a lowest position, among the plurality of upper anti-reflection layers, the third upper anti-reflection layer including a plurality of holes that are arranged periodically in two dimensions,
the second upper anti-reflection layer is on the third upper anti-reflection layer, among the plurality of upper anti-reflection layers, the second upper anti-reflection layer covering an outer surface of the third upper anti-reflection layer,
the first upper anti-reflection layer is on the second upper anti-reflection layer, among the plurality of upper anti-reflection layers, the first upper anti-reflection layer covering an outer surface of the second upper anti-reflection layer, and
a cross-sectional area of the third upper anti-reflection layer in the horizontal direction has a shape that widens toward the second meta-micro-lens array.

14. The image sensor of claim 13, wherein a refractive index of the second upper anti-reflection layer is smaller than a refractive index of the third upper anti-reflection layer and greater than a refractive index of the first upper anti-reflection layer.

15. The image sensor of claim 11, wherein a thickness of each of the plurality of upper anti-reflection layers in the vertical direction is about 100 angstroms (Å) to about 2,000 angstroms (Å).

16. The image sensor of claim 11, wherein the plurality of upper anti-reflection layers each comprise at least one material of Al₂O₃, HfO, SiO₂, AlOC, AlON, AlOCN, Ta₂O₅, or TiO₂, or any combination thereof.

17. The image sensor of claim 11, further comprising a plurality of lower anti-reflection layers on the upper surface of the sensor substrate.

18. The image sensor of claim 11, further comprising a second etch stopper between the first meta-micro-lens array and the second meta-micro-lens array.

19. An image sensor, comprising:
a sensor substrate, the sensor substrate including a plurality of first pixels and a plurality of second pixels, wherein the plurality of first pixels are configured to sense light of a first wavelength, and the plurality of second pixels are configured to sense light of a second wavelength that is different from the first wavelength;
a plurality of lower anti-reflection layers on an upper surface of the sensor substrate;
a transparent spacer above the plurality of lower anti-reflection layers;
first color filters and second color filters, the first color filters and the second color filters between the sensor substrate and the transparent spacer, the first color filters and the second color filters corresponding to the plurality of first pixels and the plurality of second pixels, respectively;
a first meta-micro-lens array including a plurality of first nano-posts, the plurality of first nano-posts above the transparent spacer, the plurality of first nano-posts configured to condense incident light onto the plurality of first pixels and the plurality of second pixels;
a second meta-micro-lens array above the first meta-micro-lens array, the second meta-micro-lens array including a plurality of second nano-posts, the plurality of second nano-posts at positions in a horizontal direction that are different from positions of the plurality of first nano-posts in the horizontal direction, such that the plurality of second nano-posts are offset from the plurality of first nano-posts in the horizontal direction, the horizontal direction extending parallel to the upper surface of the sensor substrate;
a first etch stopper between the transparent spacer and the first meta-micro-lens array; and
a plurality of upper anti-reflection layers on a light-incident surface of the second meta-micro-lens array,
wherein the plurality of upper anti-reflection layers are stacked to overlap each other in a vertical direction extending perpendicular to the upper surface of the sensor substrate,
wherein refractive indices of the plurality of upper anti-reflection layers increase toward the second meta-micro-lens array in the vertical direction, and
wherein each of the first meta-micro-lens array and the second meta-micro-lens array is configured to
change a phase of the light of the first wavelength and then condense the light of the first wavelength onto each of the plurality of first pixels, and
change a phase of the light of the second wavelength and then condense the light of the second wavelength onto each of the plurality of second pixels.

20. The image sensor of claim 19, wherein
a refractive index of each upper anti-reflection layer of the plurality of upper anti-reflection layers linearly increases by about 0.2 for every 100 nm of a thickness of the each upper anti-reflection layer in the vertical direction, and
the thickness of the each upper anti-reflection layer is about 100 angstroms (Å) to about 2,000 angstroms (Å).
